(19) United States
(12) Patent Application Publication
(10) Pub. No.: US 2019/0253491 A1
(43) Pub. Date: Aug. 15, 2019

(54) PERIPHERAL DEVICE, COMMUNICATION SYSTEM, COMMUNICATION METHOD, AND RECORDING MEDIUM STORING COMMUNICATION PROGRAM

(71) Applicant: Olympus Corporation, Tokyo (JP)

(72) Inventors: Osamu NONAKA, Sagamihara-shi (JP); Tetsuya TOYODA, Hachioji-shi (JP); Keito FUKUSHIMA, Mitaka-shi (JP); Yoshihisa OGATA, Hachioji-shi (JP); Kensei ITO, Sagamihara-shi (JP); Koichi Shintani, Hachioji-shi (JP); Katsuhisa Kawaguchi, Hachioji-shi (JP); Kazuhiko OSA, Hachioji-shi (JP)

(21) Appl. No.: 16/273,028

(22) Filed: Feb. 11, 2019

(30) Foreign Application Priority Data
Feb. 14, 2018 (JP) 2018-024422

(51) Int. Cl. H04L 29/08; G06F 13/10; G06F 13/38; H04W 8/22

(52) U.S. Cl. CPC H04L 67/1061; H04W 8/22; G06F 13/387; G06F 13/102

(57) ABSTRACT

A peripheral device communicates with a central control device. The peripheral device includes a control circuit. The control circuit is configured to transmit first information to the central control device. The first information includes a topic to be provided to the central control device or a user of the central control device.

### CROSS-REFERENCE TO RELATED APPLICATIONS

This application is based upon and claims the benefit of priority from the prior Japanese Patent Applications No. 2018-024422, filed Feb. 14, 2018, the entire contents of which are incorporated herein by reference.

### FIELD

Exemplary embodiments relate to a peripheral device communicating with a central control device, a communication device control system including the peripheral device, a communication method, and a recording medium storing a communication program.

### BACKGROUND

Along with the recent progress of artificial intelligence (AI) technology, attempts have been made to mount AI in various devices. A device called a smart speaker is known as a representative example of this type of AI-mounted device. In recent years, types for assisting image display or switch input are also on the market, but the smart speaker basically has an interactive AI assistant on the assumption of hands-free operations. In response to voice instructions from a user, the AI assistant provides various services such as reproducing music, searching for necessary information from the Internet or the like, and reporting to the user. When the learning of the AI assistant progresses, it is also expected that the AI assistant will determine the information of interest to the user and report the determined information to the user, without detailed instruction by the user. As the technique for determining the information of interest to the user is disclosed in, for example, Jpn. Pat. Appin. KOKAI Publication No. 2013-12204.

### SUMMARY

According to embodiments, there is provided a peripheral device communicating with a central control device, the peripheral device comprising: a control circuit configured to transmit first information including a topic to be provided to the central control device or a user of the central control device, wherein the first information includes information for proposal to the central control device or the user of the central control device in relation to at least one of information about a current situation of the peripheral device and information about a function of the peripheral device.

Advantages of the embodiments will be set forth in the description which follows, and in part will be obvious from the description, or may be learned. The advantages may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate embodiments, and together with the general description given above and the detailed description of the embodiments given below, serve to explain the principles.

FIG. 1 is a diagram illustrating a configuration of an example of a communication system according to first and second embodiments;

FIG. 2 is a block diagram illustrating a configuration of an example of a central control device;

FIG. 3 is a block diagram illustrating a configuration of an example of a peripheral device;

FIG. 4 is a diagram for explaining the outline of the operation of the communication system;

FIG. 5A is a diagram for explaining information transmission between the central control device and the peripheral device in the first embodiment;

FIG. 5B is a diagram for explaining information transmission between the central control device and the peripheral device in the first embodiment;

FIG. 6 is a flowchart showing the operation of the peripheral device in the first embodiment;

FIG. 7 is a flowchart showing the operation of the central control device in the first embodiment;

FIG. 8 is a diagram illustrating an example of contents of an advertising signal and detailed information communicating as second information transmission;

FIG. 9A is a diagram illustrating an example of contents of an advertising signal and detailed information communicating as third information transmission;

FIG. 9B is a diagram illustrating an example of contents of an advertising signal and detailed information communicating as third information transmission;

FIG. 9C is a diagram illustrating an example of contents of an advertising signal and detailed information communicating as third information transmission;

FIG. 10 is a flowchart showing the operation of the peripheral device in the second embodiment;

FIG. 11 is a flowchart showing an advertising signal transmission process;

FIG. 12A is a flowchart showing a state check process;

FIG. 12B is a flowchart showing the state check process;

FIG. 13 is a flowchart showing the operation of the central control device in the second embodiment;

FIG. 14A is a flowchart showing details of a response determination process;

FIG. 14B is a flowchart showing details of the response determination process;

FIG. 15A is a diagram showing an example of an imaging history of a user;

FIG. 15B is a diagram showing an example of an imaging history of a user;

FIG. 16 is a diagram illustrating a configuration of a communication system according to a third embodiment;

FIG. 17A is a flowchart showing an operation of a digital camera according to the third embodiment;

FIG. 17B is a flowchart showing the operation of the digital camera according to the third embodiment; and

FIG. 18 is a flowchart showing an operation of a smartphone in the third embodiment.

### DETAILED DESCRIPTION

Hereinafter, embodiments will be described with reference to the drawings.

### First Embodiment

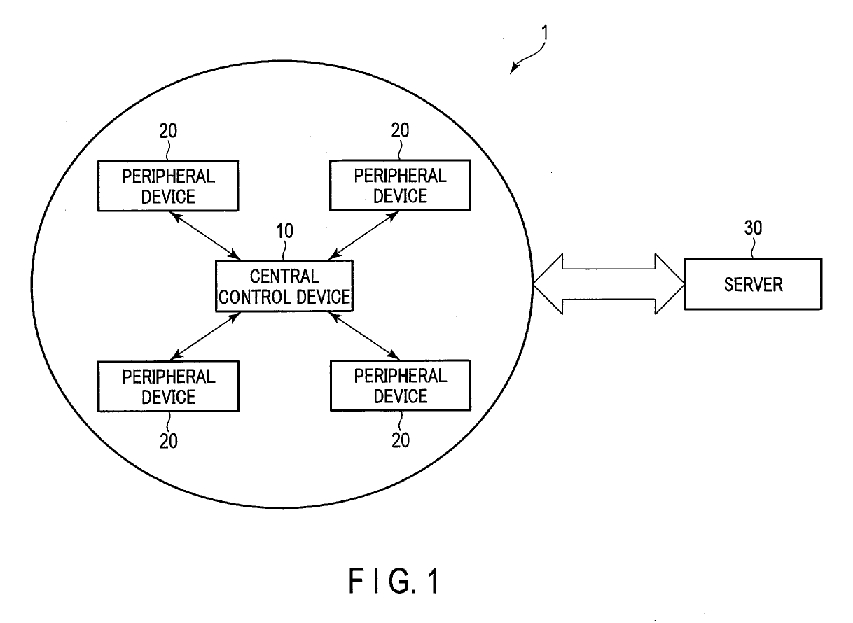

A first embodiment will be described. FIG. 1 is a diagram illustrating a configuration of an example of a communication system according to first and second embodiments. The communication system 1 includes a central control device 10 and at least one peripheral device 20. In FIG. 1, four peripheral devices 20 are illustrated. The central control device 10 and each of the peripheral devices 20 communicate with each other. In addition, the central control device 10 and each of the peripheral devices 20 communicate with a server 30. The central control device 10 and the peripheral devices 20 exist within a relatively narrow range in a house or the like. On the other hand, the server 30 may be positioned near the central control device 10 and the peripheral devices 20, or may be positioned far therefrom.

Under such environments, it is expected that AI-mounted devices such as smart speakers will become the central control device and control various Internet of Things (IoT) devices such as capture devices, audio and visual devices, and smart appliances as peripheral devices. In this case, when the AI Assistant of the central control device gives various proposals to the user and controls the peripheral devices, the central control device collects various kinds of information about the peripheral devices as needed and performs necessary cooperation or communication, and the need to summarize is assumed. Therefore, technologies that enable peripheral devices to take the initiative to provide topics in order for the central control device to perform various determinations are important. Here, attempts are made to provide peripheral devices or AI-mounted control devices having an information providing function that is effective for IoT environment by transmitting appropriate information at an appropriate timing.

The central control device 10 is, for example, a smart speaker having an interactive user interface using voice. The central control device 10 issues a variety of information from the speaker as a voice according to the user's voice. If necessary, an image display control circuit, a display panel, a touch panel, or a control circuit thereof may be provided. In addition, the central control device 10 also performs remote control of the peripheral device 20. Here, the central control device 10 has artificial intelligence. The central control device 10 may include a non-interactive user interface.

Each of the peripheral devices 20 is a device that can communicate with the central control device 10 and the server 30. The peripheral device 20 is, for example, an information device group. The information device group is a device for acquiring and managing a variety of information. The information device group includes, for example, devices such as digital cameras, voice recorders, personal computers (PCs), and smartphones. In addition, the peripheral device 20 is, for example, an audio and visual (AV) device group. The audio and visual device group is a device for recording or reproducing video or voice. The audio and visual device group includes devices such as televisions, recording devices, and audio devices. In addition, the peripheral device 20 is, for example, a smart appliance group. The smart appliance group is a home appliance having a communication function. The smart appliance group includes, for example, devices such as smart air conditioners, smart refrigerators, smart vacuum cleaners, smart toilets, and smart lighting devices. In addition, the peripheral device 20 is a home security device group. The home security device group is a device related to security in the home. The home security device group includes, for example, devices such as intercoms, surveillance cameras, and electronic locks. Here, although the peripheral devices constituting the home network are exemplified, the technology of the present embodiment can also be applied to peripheral devices constituting a network in cooperation with specific central control devices such as business places, hospitals, and laboratories. In the hospitals, the laboratories, and the like, various dedicated devices such as observation devices and inspection devices are arranged. However, there are devices in which the central control device may not necessarily constitute the network.

Here, when there are a plurality of peripheral devices 20 capable of communicating with the central control device 10, the peripheral devices 20 may be the same devices or different devices. In addition, the peripheral device 20 has only to communicate with the central control device 10, and may not be able to communicate with the server 30. In addition, the peripheral device 20 may or may not have artificial intelligence.

The server 30 stores a variety of information. The central control device 10 searches for necessary information from the information stored in the server 30. The server 30 may include a single computer or the like. In addition, the server 30 may include a plurality of computers or the like. In addition, the servers 30 may be distributed on the network.

The server 30 may work as artificial intelligence. As the artificial intelligence, circuits and programs for realizing a function of causing an action such as generating a specific process for each condition among sequential processes according to a recorded program are assumed. All of these circuits and programs need not be inside the same device. In addition, the programs for realizing the artificial intelligence may be frequently updated. For example, when the user selects only a specific branch process in sequential processes and does not select the other branch processes, the update for further subdividing the branch process with many times of selection may be performed. Therefore, customization suitable for the user is made. For example, even if simple information such as instructing turning on the power of the specific peripheral device or instructing turning off the power of the specific peripheral device is given, conditional branching may be made depending on the frequency of these instructions. For example, it is considered that users who frequently issue instructions such as turning on or off the peripheral devices frequently use the peripheral devices. In this case, when an instruction to turn on or off the power of the peripheral device is issued, the artificial intelligence presents maintenance information rather than information on how to use the peripheral device. There may be the opposite cases depending on the peripheral devices or circumstances. In addition, further advanced machine learning may be performed. For example, when learning the relationship between the voice instructing to turn on or off and the specific peripheral device, the artificial intelligence is expected to be able to determine to which one of the peripheral devices information should be given. Specifying a user by using voice can be realized by, for example, learning a voiceprint pattern of a user. In addition, as a user behavior analysis method, there is also known a technique for analyzing the behavior of the user from the usage history of information devices such as smartphones. For example, from the history of a date and time at which the information device was used and a place at which the information device was used, it can be determined which season and which day of the week the user of the information device is likely to go to, and the like. In addition, by deep learning using information such as purchase information of products or images captured with cameras, it is possible to predict user's behavior or to determine user's preference. For example, the artificial intelligence learns the relationship between time obtained by a clock embedded in an information device and a place obtained by a position detection circuit as teacher data. Therefore, the artificial intelligence can infer where the probability of going to a certain point in the future, such as the weekend of the next week, is high, and that the user would like to go there. In addition, when the artificial intelligence learns event information related to the place, the artificial intelligence can also infer what kind of event you want and when you want to go, or the like. Based on such inference, the artificial intelligence can determine that it will be pleased to search information of such an event appropriately and present the information to the user beforehand. In addition, the artificial intelligence is also expected to analyze a subject from an image captured by a camera and to infer, from the relationship between the subject and the capturing time, when the person wants to take a photograph and what kind of photograph the person wants to take. Similarly, the artificial intelligence can also determine information about the date and time and the place where a specific subject appears, based on information about the capturing date and time and capturing place of a similar image including the specific subject on the Internet or information about date and time or place contained in a text related to the specific subject. Furthermore, the artificial intelligence is expected to infer the place and the date and time appropriate for capturing by learning using information on the Internet as teacher data. With such inference, the artificial intelligence provides information to users in advance in consideration of a period that the user can prepare (for example, one month for distant places, or one week for close places). The artificial intelligence provides information of close places for users who are determined not to like long distance travel. Therefore, it is possible to provide information more reflecting the user's preference. The same way of thinking can be applied to the time to provide information. For example, the artificial intelligence may determine information that should be provided only at the timing when the user is nearby and when it is not busy time in the morning and information that should be provided in the busy time zone, and may provide the information. It is preferable that control is performed such that specific information is output by learning using time zones, categories of valid information, and categories of invalid information by causing the user to answer whether the provided information is valid for the user. When a specific user's voice is input, the artificial intelligence may provide information suitable for the user's preference, or provide similar information based on the voice input from the user. In addition, the artificial intelligence may prepare some information in advance and provide the information appropriately. In addition, even if there is no input of the voice of the specific user, when it is determined that a situation is a specific situation based on the action pattern of the user and the information about the history of the peripheral device operated by the user, the artificial intelligence may provide Information on the assumption that a specific user is present there.

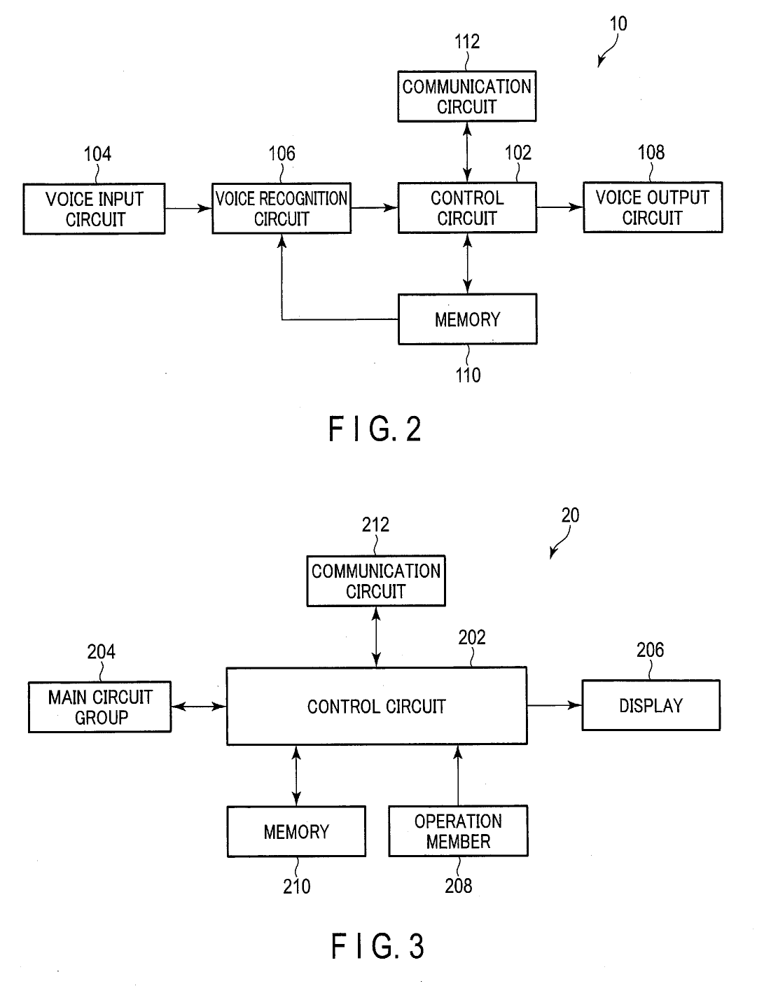

Hereinafter, the central control device 10 and the peripheral device 20 will be further described. FIG. 2 is a block diagram illustrating a configuration of an example of the central control device 10. As illustrated in FIG. 2, the central control device 10 includes a control circuit 102, a voice input circuit 104, a voice recognition circuit 106, a voice output circuit 108, a memory 110, and a communication circuit 112.

The control circuit 102 controls the operation of each block of the central control device 10. The control circuit 102 includes hardware such as a CPU, a GPU, an ASIC, an FPGA, and a main memory. The control circuit 102 also operates as an AI assistant having artificial intelligence according to programs and libraries stored in the memory 110. This artificial intelligence program may not be stored in the memory 110. For example, the artificial intelligence program may be present in the server 30. In this case, the control circuit 102 accesses the artificial intelligence of the server 30 as necessary and receives necessary information. The control circuit 102 may be constituted by a single CPU or the like, or may be constituted by a plurality of CPUs or the like. In addition, some functions of the control circuit 102 may be realized by software.

The voice input circuit 104 includes a microphone. The voice input circuit 104 acquires a voice outside the central control device 10 through the microphone. Then, the voice input circuit 104 inputs the acquired voice to the voice recognition circuit 106. The voice input circuit 104 may include a circuit or the like for removing a noise from the acquired voice.

The voice recognition circuit 106 recognizes a voice input from the voice input circuit 104. For example, the voice recognition circuit 106 decomposes the input voice and recognizes the voice by comparing the decomposed voice with an acoustic model and a word dictionary stored in the memory 110. Information such as the acoustic model and the word dictionary for voice recognition may not be stored in the memory 110. For example, the information for voice recognition may be present in the server 30.

The voice output circuit 108 includes a speaker. The voice output circuit 108 emits a voice instructed from the control circuit 102 through the speaker.

The memory 110 is a memory such as a flash memory, a hard disk, or a solid state drive. Various programs used by the central control device 10 are stored in the memory 110. In addition, the information such as the acoustic model and the word dictionary used for voice recognition are stored in the memory 110. In addition, information for identifying the peripheral device 20 is stored in the memory 110. The information for identifying the peripheral device 20 is the device name and device type of the peripheral device 20. Furthermore, information about the nominal name of the peripheral device 20 is stored in the memory 110. The information about the nominal name of the peripheral device 20 is information used when the central control device 10 reports a notification or a topic from the peripheral device 20 to the user. The information about the nominal name may be any information such as “PC1”, “smartphone 1”, “camera 1”, or “camera 2”, which is easily identifiable by the user. When registering a new peripheral device 20 in the communication system 1, the central control device 10 stores information for identifying the peripheral device 20 and information about the nominal name of the peripheral device 20 in the memory 110. The memory 110 may be single or plural. In addition, the memory 110 may not be embedded in the central control device 10. That is, all or part of the memory 110 may be positioned outside the central control device 10.

The communication circuit 112 includes a circuit for allowing the central control device 10 to communicate with an external device. For example, the communication circuit 112 includes a first communication circuit and a second communication circuit. The first communication circuit is, for example, a communication circuit for low power consumption communication such as Bluetooth (registered trademark) Low Energy (BLE). In addition, the second communication circuit is, for example, a communication circuit for high capacity communication such as Wi-Fi (registered trademark). Furthermore, the communication circuit 112 may include a communication circuit for cellular phone communication such as a fourth generation (4G) mobile phone line.

FIG. 3 is a block diagram illustrating a configuration of an example of the peripheral device 20. As illustrated in FIG. 3, the peripheral device 20 includes a control circuit 202, a main circuit group 204, a display 206, an operation member 208, a memory 210, and a communication circuit 212.

The control circuit 202 controls the operation of each block of the peripheral device 20 according to the program stored in the memory 210. The control circuit 202 includes hardware such as a CPU, a GPU, an ASIC, an FPGA, and a main memory. The control circuit 202 may be constituted by a single CPU or the like, or may be constituted by a plurality of CPUs or the like. In addition, some functions of the control circuit 202 may be realized by software.

The main circuit group 204 is a circuit group related to the main function of the peripheral device 20. Therefore, the main circuit group 204 has different circuit groups according to the type of the peripheral device 20. For example, when the peripheral device 20 is a digital camera, the main circuit group 204 includes an imaging element. In addition, for example, when the peripheral device 20 is a television, the main circuit group 204 includes a display such as a liquid crystal display. In addition, for example, when the peripheral device 20 is a smart air conditioner, the main circuit group 204 includes a circuit or the like related to cooling and heating.

The display 206 displays various images. The display 206 is a display such as a liquid crystal display or an organic EL display. Depending on the peripheral device, the display 206 may be omitted. In addition, the images are not necessarily displayed on the display 206. For example, the images may be displayed on a television monitor in a position that can communicate with the peripheral device 20.

The operation member 208 includes a mechanical operation member such as a button, a switch, and a dial. In addition, the operation member 208 may include a touch panel. For example, the touch panel is provided integrally with the display screen of the display 206.

The memory 210 is a memory such as a flash memory. Various programs used by the peripheral device 20 are stored in the memory 210. The memory 210 may be single or plural. In addition, the memory 210 does not have to be embedded in the peripheral device 20. That is, all or part of the memory 210 may be positioned outside the peripheral device 20.

The communication circuit 212 includes a circuit for allowing the peripheral device 20 to communicate with an external device. For example, the communication circuit 212 includes a first communication circuit and a second communication circuit. The first communication circuit is, for example, a communication circuit for low power consumption communication such as BLE. In addition, the second communication circuit is, for example, a communication circuit for high capacity communication such as Wi-Fi.

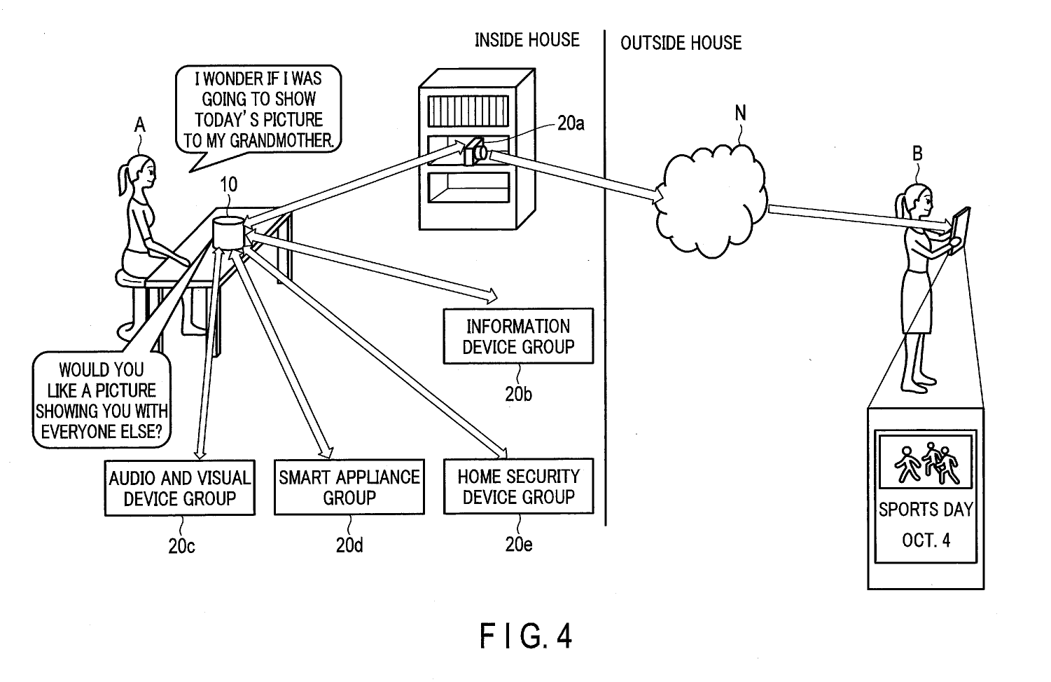

Next, the outline of the operation of the communication system 1 will be described. FIG. 4 is a diagram for explaining the outline of the operation of the communication system 1. In FIG. 4, the communication system 1 is installed in, for example, a user A′s house. As illustrated in FIG. 4, the central control device 10 is arranged so as to be able to communicate with a digital camera 20a, which is one of the peripheral devices 20. In addition, the central control device 10 is arranged so as to be able to communicate with an information device group 20b, an audio and visual device group 20c, a smart appliance group 20d, and a home security device group 20e which are the peripheral devices 20 other than the digital camera 20a.

In a situation as illustrated in FIG. 4, for example, suppose that user A murms toward the central control device 10, “Let's show today's picture to my grandmother?” At this time, the central control device 10 interprets the contents of the voice emitted by the user A. Then, the central control device 10 determines correspondence from the contents of the interpreted voice. Here, in the present embodiment, various topics are voluntarily provided from the digital camera 20a. Among the topics to be provided, for example, a topic such as “information about images captured today” is included. Since the contents of “today's picture” included in the user's voice is included, the central control device 10 determines to refer to “information about today's captured images” provided from the digital camera 20a. Then, the central control device 10 proposes a suggestion to the user A, for example, “Do you like being taken with everyone?” from the result of referring to today's captured images. When the user A replies to this proposal, the central control device 10 issues an image transmission command to the digital camera 20a. In response to this, the digital camera 20a transmits the image, in which all the family members are photographed among the images captured today, to the grandmother's smartphone as the user B through the network N.

As described above, in the present embodiment, the peripheral device 20 voluntarily provides “topic” to the central control device 10. Therefore, the central control device 10 makes it easier to make appropriate proposals and the like even when there is no “instruction” from the user. In addition, the central control device 10 makes it easier to make appropriate proposals and the like for words that are not “instructions” for the central control device 10, such as mere tweets by the user.

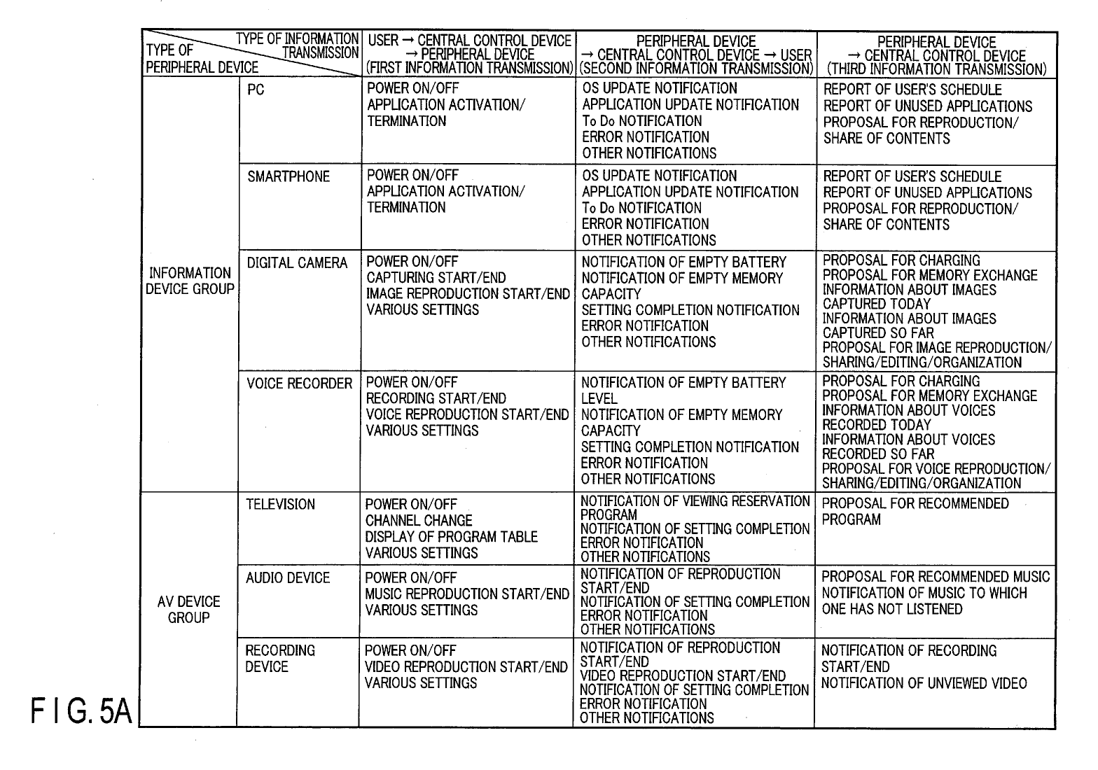

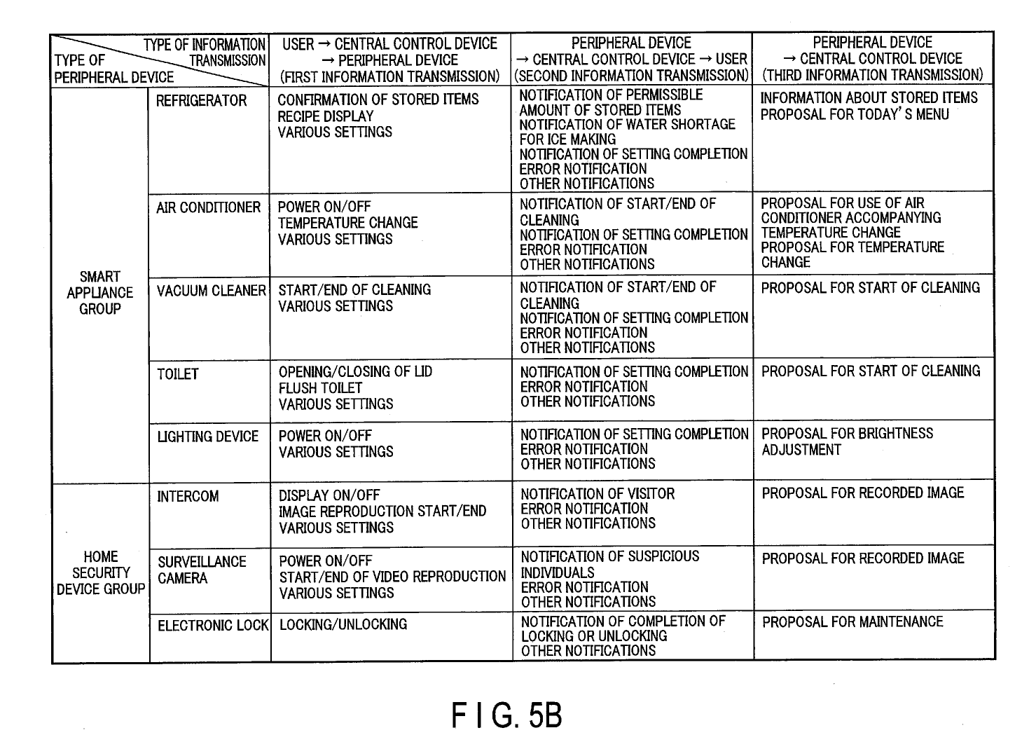

FIGS. 5A and 5B are diagrams for explaining information transmission between the central control device 10 and the peripheral device 20 in the first embodiment. In the present embodiment, information transmission between the central control device 10 and the peripheral device 20 is roughly divided into three types.

The first information transmission is intended to cause the peripheral device 20 to perform a predetermined operation based on an instruction from the user. In the first information transmission, a command based on an instruction given by the user is transmitted from the central control device 10 to the peripheral device 20. In the case of the first information transmission, the peripheral device 20 operates according to the command transmitted by the central control device 10.

The second information transmission is intended to notify the user. In the second information transmission, the information transmitted from the peripheral device 20 is transmitted to the central control device 10. In the case of the second information transmission, the central control device 10 notifies the user of the information transmitted from the peripheral device 20, for example, by emitting a voice from a speaker. In this manner, how to use the information transmitted by the second information transmission is limited to the notification.

The third information transmission is intended to provide a topic for the central control device 10 or the user. In the third information transmission, the information for providing the topic is transmitted from the peripheral device 20 to the central control device 10. The topic here is a topic to show what kind of device can be done with the peripheral device 20. This topic includes information for ‘the proposal’ to the central control device 10 or the user in relation to at least one of the information about the current situation of the peripheral device 20 and the information about the function of the peripheral device 20. In the case of the third information transmission, the central control device 10 performs various determinations by using the information transmitted from the peripheral device 20. Then, the central control device 10 proposes the user by, for example, a voice as necessary, controls the peripheral device 20, and accumulates information for another determination later. As described above, how to use the information for providing topics transmitted by the third information transmission is determined by the central control device 10.

In FIG. 5A, examples of the information device group include a PC, a smartphone, a digital camera, and a voice recorder.

As the first information transmission between the central control device 10 and the PC, the central control device 10 issues a command to the PC based on an instruction such as turning on or off the power from the user, or activating or terminating the application.

As the second information transmission between the central control device 10 and the PC, the PC transmits, to the central control device 10, a notification such as OS update notification, application update notification, To Do notification, error notification, and other notifications.

As the third information transmission between the central control device 10 and the PC, the PC transmits, to the central control device 10, information such as report of the user's schedule, report of unused applications, proposal for reproduction of specific contents, and proposal for share of specific contents. The contents here are an image, video, or voice. Note that the video here means a movie picture. In addition, the “share” means sharing information with other peripheral devices.

As the first information transmission between the central control device 10 and the smartphone, the central control device 10 issues a command to the smartphone based on an instruction such as turning on or off the power from the user, or activating or terminating the application.

As the second information transmission between the central control device 10 and the smartphone, the smartphone transmits, to the central control device 10, a notification such as OS update notification, application update notification, To Do notification, error notification, and other notifications.

As the third information transmission between the central control device 10 and the smartphone, the smartphone transmits, to the central control device 10, information such as report of the user's schedule, report of unused applications, proposal for reproduction of specific contents, and proposal for share of specific contents.

As the first information transmission between the central control device 10 and the digital camera, the central control device 10 issues, to the digital camera, a command based on an instruction such as power on or off from the user, capturing start or end, image reproduction or termination, and various settings.

As the second information transmission between the central control device 10 and the digital camera, the digital camera transmits, to the central control device 10, notification that the remaining battery level has been exhausted, notification that the remaining memory capacity has been exhausted, setting completion notification, error notification, and other notifications.

As the third information transmission between the central control device 10 and the digital camera, the digital camera transmits, to the central control device 10, proposal for charging, proposal for memory exchange, information about images captured today, information about previously captured images, proposal for reproducing specific images, proposal for sharing specific images, proposal for editing specific images, and proposal for arranging specific images.

The information about the images captured today includes, for example, information such as the presence or absence of images captured today, the total number of images captured today, the number of snapshots in the images captured today, the number of group photographs in the images captured today, the number of landscape photographs in the images captured today, the number of movies in the images captured today, and the number of failed images in the images captured today.

The information about the captured images up to now is history information about the capturing of the user so far. The information about the captured images up to now include, for example, information such as the cumulative number of images captured so far, the cumulative number of snapshots, the cumulative number of group photographs, the cumulative number of landscape pictures, the cumulative number of videos, and the cumulative number of failed images. The specific image proposed for reproduction is an image captured today, an image with a small number of times of reproductions, an image tagged with a favorite setting by the user, and the like. The specific image proposed for share is an image captured today, a group photograph, an image which has never been shared, and the like. The specific image proposed for editing is an unedited voice, an image with a small number of times of reproductions, and the like. The specific image proposed for organization is a failed image, a duplicated image, and the like.

As the first information transmission between the central control device 10 and the voice recorder, the central control device 10 issues a command to the voice recorder based on an instruction such as power on or off from the user, recording start or end, voice reproduction or termination, and various settings.

As the second information transmission between the central control device 10 and the voice recorder, the voice recorder transmits, to the central control device 10, notification of the remaining battery level, notification of the remaining memory capacity, setting completion notification, error notification, and other notifications.

As the third information transmission between the central control device 10 and the voice recorder, the voice recorder transmits, to the central control device 10, proposal for charging, proposal for memory exchange, information about voices recorded today, information about voices recorded so far, proposal for reproducing specific voices, proposal for sharing specific voices, proposal for editing specific voices, and proposal for arranging specific voices. The specific voice proposed for reproduction is a voice recorded today, a voice with a small number of times of reproductions, a favorite voice tagged with a favorite setting by the user, and the like. The specific voice proposed for share is a voice recorded today, a voice that has never been shared, and the like. The specific voice proposed for editing is an unedited voice, a voice with a small number of times of reproductions, and the like. The specific voice proposed for organization is a failed voice, a duplicated voice, and the like.

In addition, in FIG. 5A, examples of the audio and visual device group include a television, an audio device, and a recording device.

As the first information transmission between the central control device 10 and the television, the central control device 10 issues a command to the television based on an instruction such as power on or off from the user, a channel change, display of a program table, various settings, and the like.

As the second information transmission between the central control device 10 and the television, the television transmits, to the central control device 10, notifications such as notification of start of a viewing reservation program, notification of setting completion, error notification, and other notifications.

As the third information transmission between the central control device 10 and the television, the television transmits information such as a recommendation program proposal to the central control device 10.

As the first information transmission between the central control device 10 and the audio device, the central control device 10 issues a command to the audio device based on instructions such as power on or off from the user, start or end of music reproduction, and various settings.

As the second information transmission between the central control device 10 and the audio device, the audio device transmits, to the central control device 10, notifications such as notification of start or end of music reproduction, notification of setting completion, error notification, and other notifications.

As the third information transmission between the central control device 10 and the audio device, the audio device transmits, to the central control device 10, information such as proposal for recommendation of music and proposal for reproduction of music to which one has not listened.

As the first information transmission between the central control device 10 and the recording device, the central control device 10 issues a command to the recording device based on instructions such as power on or off from the user, start or end of video production, and various settings.

As the second information transmission between the central control device 10 and the recording device, the recording device transmits, to the central control device 10, notifications such as notification of start or end of video reproduction, notification of recording start or end, notification of setting completion notification, error notification, and other notifications.

As the third information transmission between the central control device 10 and the recording device, the recording device transmits, to the central control device 10, information such as proposal for recommended programs and proposal for reproduction of unviewed video.

In addition, in FIG. 5B, examples of the smart appliance group include a refrigerator, an air conditioner, a vacuum cleaner, a toilet, and a lighting device.

As the first information transmission between the central control device 10 and the refrigerator, the central control device 10 issues a command to the refrigerator based on instructions such as confirmation of stored items, recipe display using ingredients in the refrigerator, and various settings.

As the second information transmission between the central control device 10 and the refrigerator, the refrigerator transmits, to the central control device 10, notifications such as notification of permissible amount of stored items, notification of water shortage for ice making, notification of setting completion, error notification, and other notifications.

As the third information transmission between the central control device 10 and the refrigerator, the refrigerator transmits, to the central control device 10, information such as information about the stored items and proposal for today's menu.

As the first information transmission between the central control device 10 and the air conditioner, the central control device 10 issues a command to the air conditioner based on instructions such as power on or off from the user, set temperature change, and various settings.

As the second information transmission between the central control device 10 and the air conditioner, the air conditioner transmits, to the central control device 10, notifications such as notification of start or end of cleaning, notification of setting completion, error notification, and other notifications.

As the third information transmission between the central control device 10 and the air conditioner, the air conditioner transmits, to the central control device 10, information such as proposal for use of air conditioner accompanying temperature change and proposal for temperature change.

As the first information transmission between the central control device 10 and the vacuum cleaner, the central control device 10 issues a command to the vacuum cleaner based on instructions such as start or end of cleaning from the user and various settings.

As the second information transmission between the central control device 10 and the vacuum cleaner, the vacuum cleaner transmits, to the central control device 10, notifications such as notification of start or end of cleaning, notification of setting completion, error notification, and other notifications.

As the third information transmission between the central control device 10 and the vacuum cleaner, the vacuum cleaner transmits information such as proposal for start of cleaning to the central control device 10.

As the first information transmission between the central control device 10 and the lighting device, the central control device 10 issues a command to the lighting device based on instructions such as power on or off from the user and various settings.

As the second information transmission between the central control device 10 and the lighting device, the lighting device transmits, to the central control device 10, notifications such as notification of setting completion, error notification, and other notifications.

As the third information transmission between the central control device 10 and the lighting device, the lighting device transmits information such as proposal for brightness adjustment to the central control device 10.

In FIG. 5B, examples of the home security device group include an intercom, a surveillance camera, and an electronic lock.

As the first information transmission between the central control device 10 and the intercom, the central control device 10 issues a command to the intercom based on instructions such as display on or off of external video, start or end of recorded image reproduction, and various settings.

As the second information transmission between the central control device 10 and the intercom, the intercom transmits, to the central control device 10, notifications such as notification of a visitor, error notification, or other notifications.

As the third information transmission between the central control device 10 and the intercom, the intercom transmits information such as proposal for reproduction of the recorded image to the central control device 10.

As the first information transmission between the central control device 10 and the surveillance camera, the central control device 10 transmits a command to the surveillance camera based on instructions such as power on or off, start or end of the video reproduction, and various settings.

As the second information transmission between the central control device 10 and the surveillance camera, the surveillance camera transmits, to the central control device 10, notifications such as notification of suspicious individuals, error notification, and other notifications.

As the third information transmission between the central control device 10 and the surveillance camera, the surveillance camera transmits, to the central control device 10, information such as proposal for reproduction of recorded video.

As the first information transmission between the central control device 10 and the electronic lock, the central control device 10 issues a command to the electronic lock based on instructions such as locking or unlocking.

As the second information transmission between the central control device 10 and the electronic lock, the electronic lock transmits, to the central control device 10, notifications such as notification of locking or unlocking and other notifications.

As the third information transmission between the central control device 10 and the electronic lock, the electronic lock transmits information such as proposal for maintenance to the central control device 10.

Here, the contents of the first information transmission, the second information transmission, and the third information transmission illustrated in FIGS. 5A and 5B are examples. In the first information transmission, the second information transmission, and the third information transmission, those other than those illustrated in FIGS. 5A and 5B may be included, and there may be no part of what is illustrated in FIG. 5A and FIG. 5B.

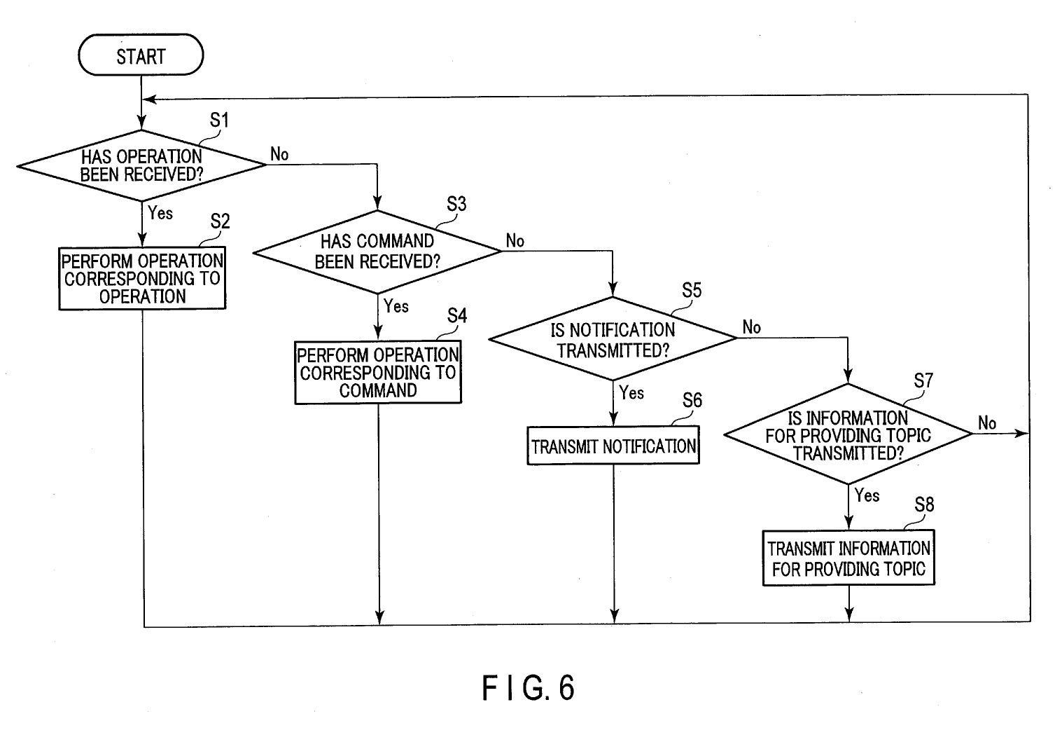

Next, the operation of the communication system 1 will be described. FIG. 6 is a flowchart showing the operation of the peripheral device 20 in the first embodiment. The operation of FIG. 6 is controlled by the control circuit 202 of the peripheral device 20. The operation illustrated in FIG. 6 may be performed in any case when the peripheral device 20 is powered on or off.

In step S1, the control circuit 202 determines whether there is the operation of the operation member 208 by the user. When it is determined in step S1 that the operation member 208 has been operated by the user, the process proceeds to step S2. When it is determined in step S1 that there is no operation of the operation member 208 by the user, the process proceeds to step S3.

In step S2, the control circuit 202 performs an operation corresponding to the operation member 208 operated by the user. After the operation is performed, the process returns to step S1. The operation corresponding to the operation member 208 is, for example, the power on of the peripheral device 20 accompanying the on operation of the power switch, or the power off of the peripheral device 20 accompanying the off operation of the power switch. In addition, the operation corresponding to the operation member 208 is an operation of various settings according to the operation of the operation member 208.

In step S3, the control circuit 202 determines whether a command from the central control device 10 has been received. When it is determined in step S3 that the command from the central control device 10 has been received, the process proceeds to step S4. When it is determined in step S3 that the command from the central control device 10 has not been received, the process proceeds to step S5.

In step S4, the control circuit 202 performs an operation corresponding to the command. After the operation is performed, the process returns to step S1. The operation corresponding to the command is the power on of the peripheral device 20 accompanying the power on command or the power off of the peripheral device 20 accompanying the power off command as illustrated as the first information transmission in FIGS. 5A and 5B. In addition, the operation corresponding to the command is various setting operations as illustrated as the first information transmission in FIG. 5A and FIG. 5B.

In step S5, the control circuit 202 determines whether to transmit the notification. In this determination, the control circuit 202 checks the state of the peripheral device 20. Then, when it matches the condition of any notification as illustrated as the second information transmission in FIGS. 5A and 5B, the control circuit 202 determines to transmit the notification. When it is determined to transmit the notification in step S5, the process proceeds to step S6. When it is determined not to transmit the notification in step SS, the process proceeds to step S7.

For example, when the peripheral device 20 is the digital camera, the control circuit 202 checks whether there is the remaining battery level, whether there is the capacity of the memory 210, whether the setting instructed by the user is completed, whether an error has occurred, and whether it is necessary to perform other notifications. Then, when any one of the conditions is satisfied, the control circuit 202 determines to transmit the notification. Here, it may be determined that it is unnecessary to transmit again for the notification reported as being notified from the central control device 10.

In step S6, the control circuit 202 transmits the notification determined to be transmitted by using the communication circuit 212. After that, the process returns to step S1. At this time, the control circuit 202 may include, in the notification, information indicating that the information to be transmitted is the notification.

Here, when the notification that needs to be repeatedly reported is included in the notification determined to be transmitted, the control circuit 202 associates repetitive information with the notification. The repetitive information is information with or without necessity of repetitive report of the same notification. For example, it is better for error notification to be performed until the error is resolved. The control circuit 202 associates the repetitive information with such notification. Furthermore, when information about a specific user is included in the notification determined to be transmitted, the control circuit 202 associates security information with the notification. The security information is, for example, a user name. For example, smartphones are devices that are supposed to be used by individuals. Therefore, notification from the smartphone can be made only to the user of the smartphone. Therefore, when the peripheral device 20 is the smartphone, the control circuit 202 associates security information with the notification.

In step S7, the control circuit 202 determines whether to transmit information for providing topics. Hereinafter, the information for providing the topics is called topic information. In this determination, the control circuit 202 determines that the topic information should be transmitted when it matches the topic provision condition illustrated as the third information transmission in FIGS. 5A and 5B. When it is determined in step S7 that the topic information is determined to be transmitted, the process proceeds to step S8. When it is determined in step S7 that the topic information is determined not to be transmitted, the process returns to step S1.

For example, when the peripheral device 20 is the digital camera, the control circuit 202 performs various determinations such as whether the remaining battery level is smaller than a predetermined level, whether the memory capacity is smaller than a predetermined amount, whether there is an image captured today, whether there is an image subject to reproduction proposal, whether there is an image proposed for share, whether there is an image subject to editing proposal, and whether there is an image subject to organization proposal. Then, when any one of the conditions is satisfied, the control circuit 202 determines to transmit the topic information.

In step S8, the control circuit 202 transmits the topic information determined to be transmitted by using the communication circuit 212. At this time, the control circuit 202 may include, in the topic information, information indicating that the information to be transmitted is the topic information. After that, the process returns to step S1.

Here, when the information that needs to be repeatedly reported is included in the topic information determined to be transmitted, the control circuit 202 associates repetitive information with the topic information. The repetitive information is information with or without necessity of repetitive report of the same topic information. For example, it is preferable that the proposal for charging in the digital camera is performed until charging is done. The control circuit 202 associates the repetitive information with such topic information. Furthermore, when information about a specific user is included in the topic information determined to be transmitted, the control circuit 202 associates security information with the topic information. The security information is, for example, a user name. For example, the proposal for the image reproduction of share may possibly touch personal privacy depending on the capturing location of the image. In such a case, the control circuit 202 associates the topic information with the security information.

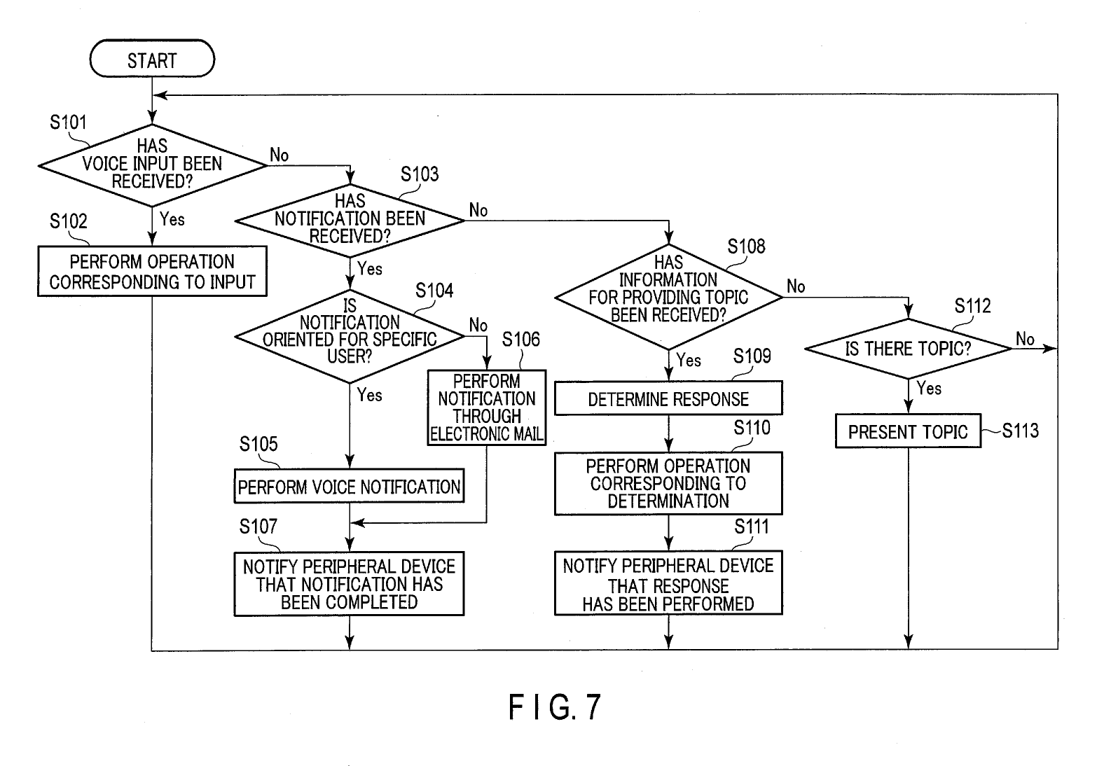

FIG. 7 is a flowchart showing the operation of the central control device 10 in the first embodiment. The operation of FIG. 7 is controlled by the AI assistant realized by the control circuit 102 or the like of the central control device 10.

In step S101, the AI assistant determines whether there is input of user's voice. When it is determined in step S101 that the user's voice is input, the process proceeds to step S102. When it is determined in step S101 that there is no input of the user's voice, the process proceeds to step S103. A specific activation word may be set in the central control device 10. In this case, in step S101, the AI assistant does not have to receive other voice inputs until the user issues an activation word. In addition, in step S101, the AI assistant may not receive input of voice other than those registered in advance.

In step S102, the AI assistant recognizes the input voice and performs an operation corresponding to the recognized voice. After that, the process returns to step S101. For example, when the input voice includes an instruction to the peripheral device 20, the AI assistant transmits a command corresponding to the instruction to the corresponding peripheral device 20 by using the communication circuit 112. In addition, when the input voice includes a reproduction instruction of a specific music, the AI assistant reproduces music from the voice output circuit 108 while searching the Internet as necessary. When the input voice includes a news reproduction instruction, the AI assistant reproduces the news from the voice output circuit 108 while searching the Internet as necessary. Furthermore, if necessary, the AI assistant may determine correspondence by using both the user's voice contents and topic information provided from the peripheral device 20. For example, as illustrated in FIG. 4, the AI assistant may perform correspondence by using “information about the image captured today” provided from the digital camera against tweets such as “Let's show today's picture to my grandmother?” from the user.

In step S103, the AI assistant determines whether the notification has been received from the peripheral device 20. When it is determined in step S103 that the notification has been received from the peripheral device 20, the process proceeds to step S104. When it is determined in step S103 that the notification has not been received from the peripheral device 20, the process proceeds to step S107.

In step S104, the AI assistant determines whether the notification is for the specific user. When the security information is associated with the notification, it is determined that the notification is for the specific user. When it is determined in step S104 that the notification is for the specific user, the process proceeds to step S105. When it is determined in step S104 that the notification is not for the specific user, the process proceeds to step S106.

In step S105, the AI assistant performs a voice notification by using the speaker of the voice output circuit 108. For example, the AI assistant performs a notification that “the battery of the camera 1 has run out”. Here, in step S105, the AI assistant may perform a notification only when the user is nearby. In step S106, the AI assistant transmits an e-mail including the notification from the peripheral device 20 to the smartphone of the specific user by using the communication circuit 112. Here, in step S106, the AI assistant may perform a voice notification when only the specific user is nearby. After step S105 or step S106, the process proceeds to step S107. Here, when the repetitive information is associated with the notification, the AI assistant periodically performs notification until a report-unnecessary instruction is received from the user.

In step S107, the AI assistant notifies the peripheral device 20 that the notification has been performed by using the communication circuit 112. After that, the process returns to step S101.

In step S108, the AI assistant determines whether the topic information has been received from the peripheral device 20. When it is determined in step S108 that the topic information has been received from the peripheral device 20, the process proceeds to step S109. When it is determined in step S108 that the topic information has not been received from the peripheral device 20, the process proceeds to step S112.

In step S109, the AI assistant determines a response based on the provided topic information. After that, the process returns to step S110. For example, when the proposal for charging is provided as the topical information, the AI assistant determines whether to propose charging to the user. For example, when the proposal for image editing is provided as the topic information, the AI assistant determines whether to propose editing of the image. The AI assistant may determine a response by integrating topic information provided from the peripheral devices 20. For example, when the proposal for sharing of contents is received from the PC or the smartphone and the proposal for image sharing is received from the digital camera, the AI assistant may determine the proposal for transmitting the image of the digital camera to the PC or the smartphone as the response. Furthermore, the AI assistant may determine the response across the peripheral devices 20. For example, when the user's schedule of going out is grasped by the PC or the smartphone, the AI assistant performs, as the response, making cleaning done by the vacuum cleaner while going out, or making the refrigerator investigate the food and drink often taken out by the user while going out. In addition, at the same time, the AI assistant may determine to propose the user to carry the digital camera when going out. In addition, the response determined by the topic information provided from the peripheral device 20 may not be limited to one. In this case, the AI Assistant may determine to allow the user to select one of the responses.

In step S110, the AI assistant performs an operation according to the determination. After that, the process proceeds to step S111. For example, the AI assistant proposes charging to the user in such a manner as “charging is proposed from camera 1”, or proposes editing of unedited images in such a manner as “unedited image seems to be in camera 1”. Here, in step S110, the AI assistant may perform proposals or the like only when the user is nearby. In addition, when the security information is associated with the provided topic information, the proposal is performed by e-mail other than voice. In addition, the AI assistant may perform proposals by voice when only the specific user is nearby. Also, when the repetitive information is associated with the provided topic information, the AI assistant periodically performs proposals or the like until a report-unnecessary instruction is received from the user. In addition, as a result of the determination, it is considered that only the topic information is stored in the central control device 10. In such a case, the AI Assistant does not perform anything in particular. The topic information accumulated in step S110 may be used, for example, when the voice is input from the user or when another topic information is provided.

In step S111, the AI assistant notifies the peripheral device 20 that the response has been performed based on the provided topic information by using the communication circuit 112. After that, the process returns to step S101. Note that when the response is performed across the peripheral devices 20, the AI assistant notifies each peripheral device.

In step S112, the AI assistant determines whether there is a topic to be newly reported to the user. The topic in step S112 is a topic with a little relation to topic information provided from the peripheral device 20, such as news or weather forecast. When it is determined in step S112 that there is the topic to be newly reported to the user, the process proceeds to step S113. When it is determined in step S112 that there is no topic to be newly reported to the user, the process returns to step S101.

In step S113, the AI assistant reports the topic to the user by, for example, using the speaker of the voice output circuit 108. After that, the process returns to step S101.

As described above, according to the present embodiment, in the communication system including the central control device and the peripheral device, the peripheral device voluntarily provides the central control device with the topic information that can be the topic. Therefore, it is expected that the AI Assistant of the central control device will make it easier to perform various determinations. In addition, since the peripheral device voluntarily provides the central control device with the topic information that can be the topic, it is also expected to increase the utility value of each of the peripheral devices.

### Second Embodiment

Next, a second embodiment will be described. In the second embodiment, the second information transmission and the third information transmission are performed by using communication with low power consumption, as compared with the first embodiment. Hereinafter, a difference from the first embodiment will be mainly described. For example, even in the second embodiment, those illustrated in FIGS. 1 to 3 are applied as the basic configuration of the communication system 1. Therefore, a description of the basic configuration as the communication system 1 will be omitted. In addition, in the following description, it is assumed that the peripheral device 20 is the digital camera. However, the technique of the second embodiment is applied to various peripheral devices other than the digital camera.

In the second embodiment, the information transmitted as the second information transmission is divided into summary and details. Similarly, in the second embodiment, the information to be transmitted as the third information transmission is divided into summary and details.

The summary is information about the summary of information to be transmitted to the central control device 10. The summary is information with a smaller amount of data than the details. This summary is included in an advertising signal and transmitted. The advertising signal is a low power consumption signal transmitted for allowing the central control device 10 to discover the peripheral device 20 before communication connection is established by the first communication circuit between the peripheral device 20 and the central control device 10. When the advertising signal is detected, the central control device 10 issues a connection permission signal to the peripheral device 20. Therefore, the communication between the peripheral device 20 and the central control device 10 is established. The communication with low power consumption can be performed by using such an advertising signal. Since the advertising signal is a signal with low power consumption, it is difficult to include large capacity information. Therefore, in the second embodiment, only the summary of the information to be transmitted to the central control device 10 is included in the advertising signal.

The details are details of the information to be transmitted to the central control device 10. Detailed information including the details is transmitted from the peripheral device 20 to the central control device 10 when a request from the central control device 10 is received. The detailed information is transmitted after the communication is established by the second communication circuit between the central control device 10 and the peripheral device 20.

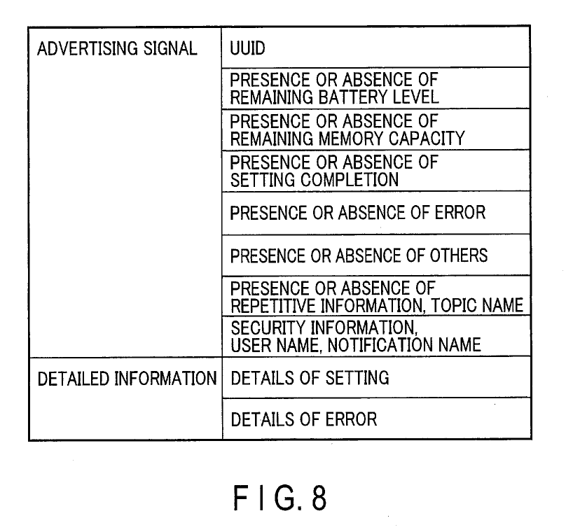

FIG. 8 is a diagram illustrating an example of contents of the advertising signal and the detailed information communicating as the second information transmission.

As illustrated in FIG. 8, the advertising signal in the second information transmission includes a universally unique identifier (UUID). The UUID is an ID uniquely assigned to each peripheral device. The central control device 10 specifies the peripheral device 20 by the UUID included in the advertising signal. In addition, as the summary of the notification, for example, the advertising signal includes information indicating the presence or absence of the remaining battery level, information indicating the presence or absence of memory remaining capacity, information indicating the presence or absence of setting completion, information indicating the presence or absence of error, information indicating the presence or absence of other notifications, repetitive information indicating the necessity of repeated notifications, and security information indicating that the notification is for the specific user.

As illustrated in FIG. 8, the detailed information includes, for example, details of the setting and details of the error as the details of the notification. The details of the setting indicate, for example, what kind of setting is completed and how the setting is completed. The details of the error indicates, for example, what kind of error has occurred. The details of the error may include, for example, an error handling method.

Here, the contents of the advertising signal and the detailed information illustrated in FIG. 8 are examples. The advertising signal or the detailed information may include those other than that illustrated in FIG. 8, or a part of those illustrated in FIG. 8 may not be included. However, the UUID is included in the advertising signal. In addition, the contents of the “summary” included in the advertising signal is not limited to the presence or absence of information. Information as much as the capacity of the advertising signal is permitted may be included in the “summary”. In addition, the content of the “summary” may be compressed and included in the advertising signal.

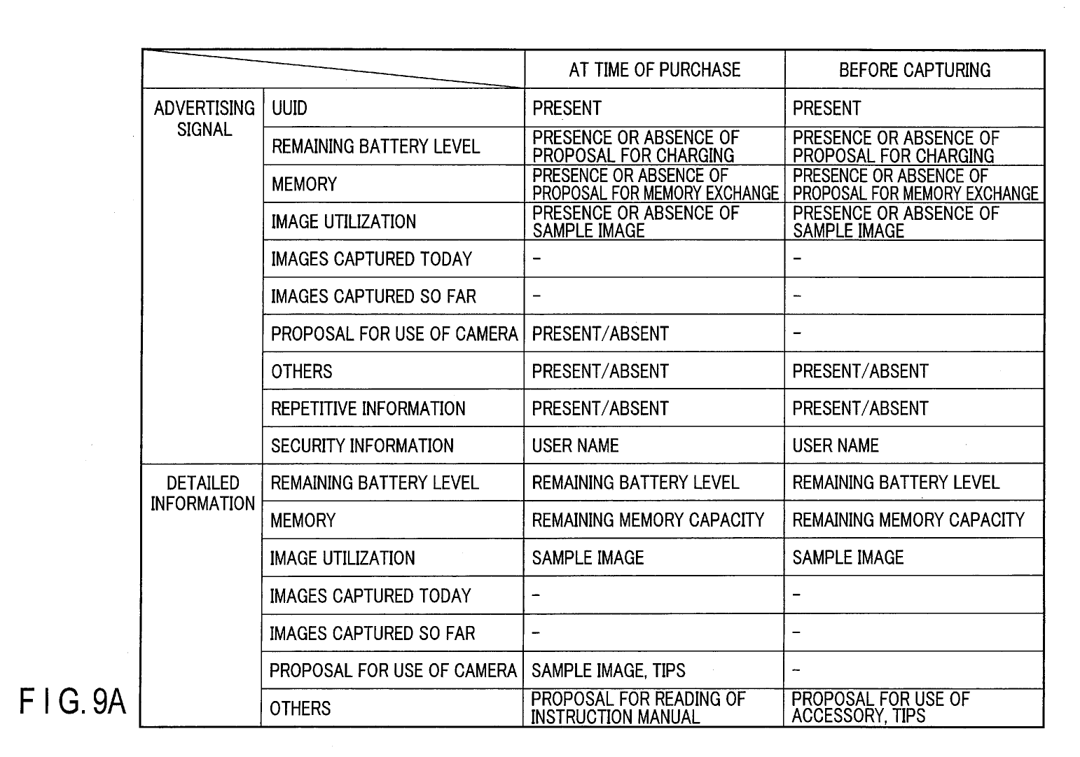

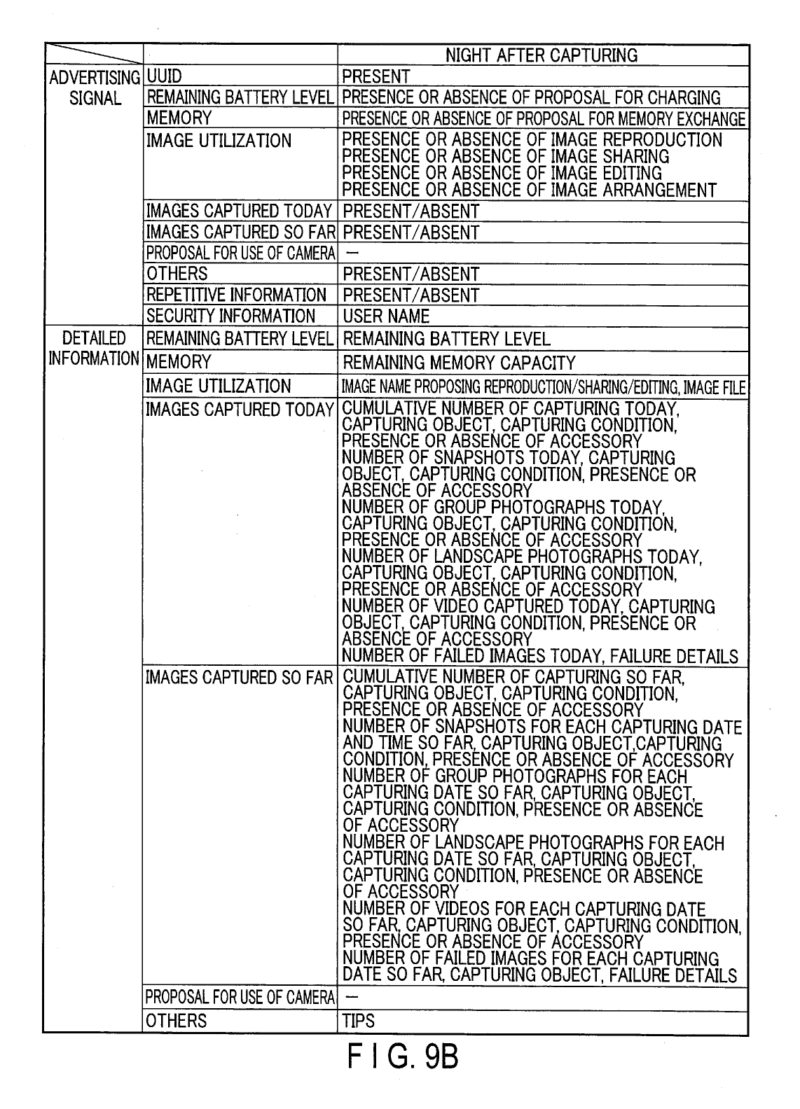

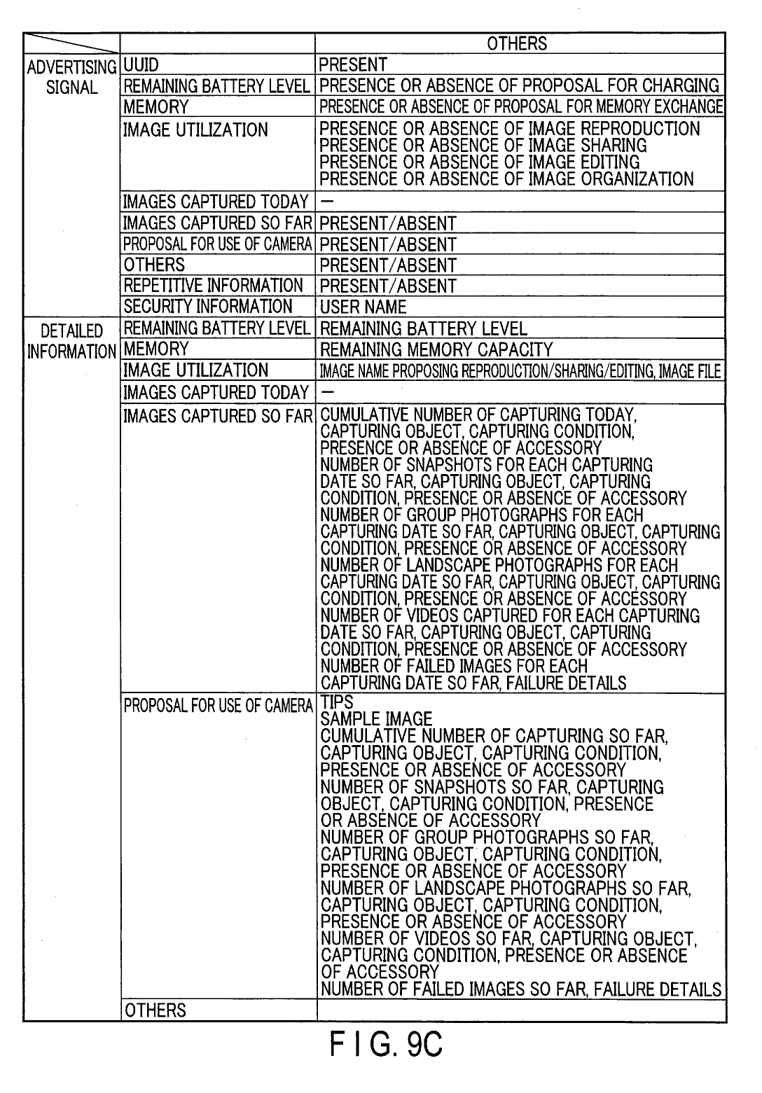

FIGS. 9A, 9B, and 9C are diagrams illustrating examples of the contents of the advertising signal and the detailed information communicating as the third information, transmission.

As illustrated in FIGS. 9A, 9B, and 9C, the advertising signal in the third information transmission also includes the UUID. In addition, as the summary, the advertising signal in the third information transmission includes topics on the remaining battery level, topics on the remaining memory capacity, topics on the image utilization, the images captured today, topics on previously captured images, topics on the use of the camera, other topics, repetitive information indicating the necessity of repeated topic reporting, and security information indicating that the topic is for the specific user.

Furthermore, information different from an advertising signal transmitted at the time of purchase of the digital camera, an advertising signal transmitted before capturing, an advertising signal transmitted on night after capturing, and an advertising signal transmitted in other situations may be included.

The advertising signal at the time of purchase includes information about the presence or absence of proposal for charging as the summary of topics on the remaining battery level. The advertising signal at the time of purchase includes information about the presence or absence of proposal for memory exchange as the summary of topics on the remaining memory capacity. The advertising signal at the time of purchase includes information about the presence or absence of the sample image as the summary of topics on the image utilization. The advertising signal at the time of purchase includes information about the presence or absence of proposal for use as the summary of topics on the use of the camera. The advertising signal at the time of purchase includes information about the presence or absence of topic as the summary of other topics. The advertising signal at the time of purchase includes repetitive information. The advertising signal at the time of purchase includes security information.

The advertising signal before capturing includes information about the presence or absence of proposal for charging as the summary of topics on the remaining battery level. The advertising signal before capturing includes information about the presence or absence of proposal for memory exchange as the summary of topics on the remaining memory capacity. The advertising signal before capturing includes information about the presence or absence of the sample image as the summary of topics on the image utilization. The advertising signal before capturing includes information about the presence or absence of topic as the summary of other information. The advertising signal before capturing includes repetitive information. The advertising signal before capturing includes security information.

The advertising signal of night after capturing includes information about the presence or absence of proposal for charging as the summary of topics on the remaining battery level. The advertising signal of night after capturing includes information about the presence or absence of proposal for memory exchange as the summary of topics on the remaining memory capacity. As the summary of topics related to the image utilization, the advertising signal of night after capturing includes information about the presence or absence of image reproduction proposal, image share proposal, image editing, and image organization proposal. As the summary of the information about the image captured today, the advertising signal of night after capturing includes information about the presence or absence of information about the image captured today. As the summary of the information about the images captured so far, the advertising signal of night after capturing includes information about the presence or absence of information about the images captured so far. The advertising signal of night after capturing includes information about the presence or absence of topic as the summary of other topics. The advertising signal of night after capturing includes repetitive information. The advertising signal of night after capturing includes security information.

In addition, even when it does not correspond to at the time of the purchase, before capturing, and night after capturing, for example, as the summary of topics on the remaining battery level, the advertising signal including information indicating the presence or absence of charging proposal is transmitted when the remaining battery level is low. In addition, when the remaining memory capacity is small, the advertising signal including information about the presence or absence of proposal for memory exchange is transmitted as the summary of topics related to the remaining memory capacity. In addition, when there is an image that is not reproduced, shared, edited, or arranged, the advertising signal including information about the presence or absence of proposal for image reproduction, share, editing, or organization is transmitted as the summary of topics related to the image utilization. In addition, when there is no long-term use of the digital camera, the advertising signal including information about the presence or absence of proposal related to the use of the camera and information about the presence or absence of information about the images captured so far is transmitted.

As illustrated in FIGS. 9A, 9B, and 9C, the detailed information in the third information transmission includes details of topics on the remaining battery level, details of topics on the remaining memory capacity, details of topics on the image utilization, details of topics on the images captured today, details of topics on the images captured so far, details of topics on the use of the camera, and details of other topics.

Furthermore, information different from the detailed information transmitted at the time of purchase of the digital camera, the detailed information transmitted before capturing, the detailed information transmitted at night after capturing, and the detailed information transmitted in other circumstances may be included.

The detailed information at the time of purchase includes the value of the actual remaining battery level as details of the topics on the remaining battery level. The detailed information at the time of purchase includes the value of the actual remaining memory capacity as details of the topic on the remaining memory capacity. The detailed information at the time of purchase includes an image file name of the sample image as details of topics related to the image utilization. The detailed information at the time of purchase may include an image file itself of the sample image as details of topics related to the image utilization. The detailed information at the time of purchase includes various tips for advising the image file of the sample image and how to use the digital camera as details of topics related to the use of the camera. In addition, the detailed information at the time of purchase includes details such as proposal for reading an instruction manual, proposal for initial setting, introduction of optional items, or the like as details of other topics.

The detailed information before capturing includes the value of the actual remaining battery level as details of the topics on the remaining battery level. The detailed information before capturing includes the value of the actual remaining memory capacity as details of the topic on the remaining memory capacity. The detailed information before capturing includes an image file name of the sample image as details of topics related to the image utilization. The detailed information before capturing may include an image file itself of the sample image as details of topics related to the image utilization. The detailed information before capturing includes various tips for advising proposals on the use of specific accessories according to capturing scenes and how to use the digital camera as details of other topics.

The detailed information of night after capturing includes the value of the actual remaining battery level as details of the topics on the remaining battery level. The detailed information of night after capturing includes the value of the actual remaining memory capacity as details of the topic on the remaining memory capacity. The detailed information of night after capturing includes the image file name of the subject of proposal for image reproduction, image sharing, image editing as details of topics related to the image utilization. The detailed information of night after capturing may include the image file itself of the subject of proposal for image reproduction, image sharing, image editing as details of topics related to the image utilization. The detailed information of night after capturing includes information about the cumulative number of images captured today, the subject to be imaged for each capturing, capturing conditions, and the presence or absence of accessory as details of the information about the images captured today. The detailed information of night after capturing includes today's snapshots, group photographs, landscape photographs, the number of captured movie images, capturing subjects for each of these capturing, capturing conditions, and presence or absence of accessories as details of information about the images captured today. The detailed information of night after capturing includes the information about the number of failed images captured today and the details of each failure as details of the information about the images captured today. The failure information includes information such as the presence or absence of out-of-focus, the presence or absence of blown-out highlight, the presence or absence of blocked-up shadow, and many similar pictures. In addition, the failure information may include technical advice for not failing. The detailed information of night after capturing includes information about the cumulative number of images captured so far, the subject to be imaged for each capturing, capturing conditions, and the presence or absence of accessory as details of the information about the images captured so far. The detailed information of night after capturing includes snapshots captured so far, group photographs, landscape photographs, the number of captured movie images, capturing subjects for each of these capturing dates, capturing conditions, and presence or absence of accessories as details of information about the images captured so far. The detailed information of night after capturing includes the information about the number of failed images captured so far and the details of each failure as details of the information about the images captured so far.

In addition, even when it does not correspond to at the time of purchase, before capturing, and night after capturing, the detailed information including the value of the actual remaining battery level may be transmitted when the advertising signal including the summary of the topic on the remaining battery level is transmitted. In addition, the detailed information including the value of the actual remaining memory capacity may be transmitted when the advertising signal including the summary of the topic on the remaining memory capacity is transmitted. In addition, when the advertising signal including the summary of topics related to the image utilization is transmitted, the detailed information including the image file name proposed for image reproduction, sharing, or editing can be transmitted. In addition, when the advertising signal including the summary of the information about the already captured image is transmitted, the detailed information including details of the information about the already captured image can be transmitted. In addition, when the advertising signal including the summary of topics related to the use of the camera is transmitted, the image file name of the sample image, various tips for advising how to use the digital camera, detailed information including details of the information about the images captured so far can be transmitted.

Here, the contents of the advertising signal and the detailed information illustrated in FIGS. 9A, 9B, and 9C are examples. The advertising signal or the detailed information may include those other than those illustrated in FIGS. 9A, 9B, and 9C, or a part of those illustrated in FIGS. 9A, 9B, and 9C may not be included. However, the UUID is included in the advertising signal. In addition, the contents of the “summary” included in the advertising signal is not limited to the presence or absence of information. Information as much as the capacity of the advertising signal is permitted may be included in the “summary”. In addition, the content of the “summary” may be compressed and included in the advertising signal.

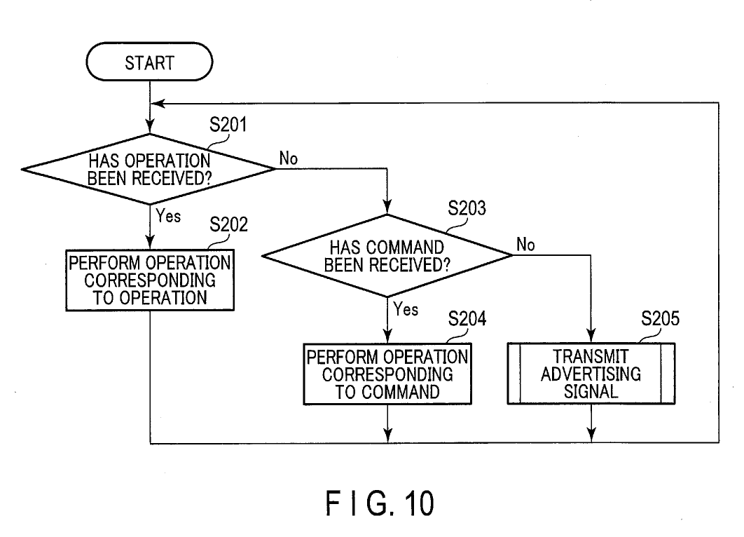

Next, the operation of the communication system 1 will be described. FIG. 10 is a flowchart showing the operation of the peripheral device 20 in the second embodiment. The operation of FIG. 10 is controlled by the control circuit 202 of the peripheral device 20. The operation illustrated in FIG. 10 may be performed in any case when the peripheral device 20 is powered on or off.

In step S201, the control circuit 202 determines whether there is the operation of the operation member 208 by the user. When it is determined in step S201 that the operation member 208 has been operated by the user, the process proceeds to step S202. When it is determined in step S201 that there is no operation of the operation member 208 by the user, the process proceeds to step S203.

In step S202, the control circuit 202 performs an operation corresponding to the operation member 208 operated by the user. After the operation is performed, the process returns to step S201.

In step S203, the control circuit 202 determines whether a command from the central control device 10 has been received. When it is determined in step S203 that the command from the central control device 10 has been received, the process proceeds to step S204. When it is determined in step S203 that the command from the central control device 10 has not been received, the process proceeds to step S205.

In step S204, the control circuit 202 performs an operation corresponding to the command. After the operation is performed, the process returns to step S201.

In step S205, the control circuit 202 performs an advertising signal transmission process. After the advertising signal transmission process, the process returns to step S201. The advertising signal transmission process is a process of determining whether to transmit an advertising signal including notification or topic information.

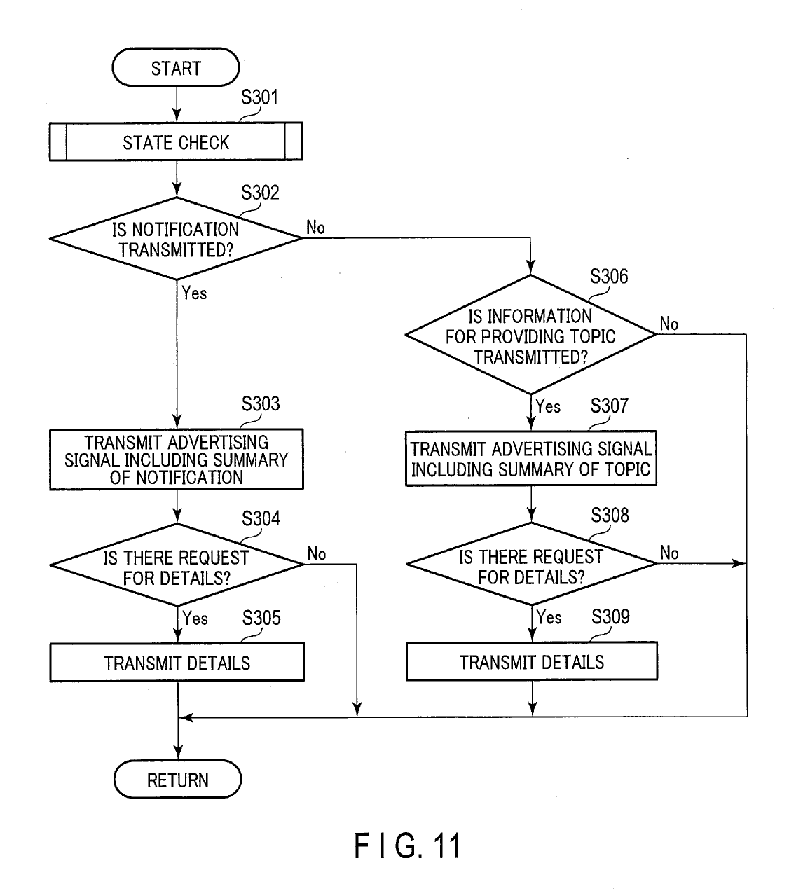

FIG. 11 is a flowchart showing the advertising signal transmission process. In step S301, the control circuit 202 performs a state check process. After that, the process proceeds to step S302. The state check process is a process of checking whether there is a notification and whether there is information for providing a topic. The state check process will be described in detail later.

In step S302, the control circuit 202 determines whether to transmit the notification from the result of the state check process. When it is determined to transmit the notification in step S302, the process proceeds to step S303. When it is determined not to transmit the notification in step S302, the process proceeds to step S306.

In step S303, the control circuit 202 transmits the advertising signal including the summary of the notification determined to be transmitted by using the communication circuit 212. At this time, the control circuit 202 may include, in the advertising signal, information indicating that the information to be transmitted includes the summary of the notification. After that, the process proceeds to step S304.

In step S304, the control circuit 202 determines whether there is a request for details as well as connection permission. When it is determined in step S304 that there is the request for details, the process proceeds to step S305. When it is determined in step S304 that there is no request for details, the process of FIG. 11 is ended.

In step S305, the control circuit 202 transmits detailed information including the details requested from the central control device 10 to the central control device 10 by, for example, using the communication circuit 212. After that, the process of FIG. 11 is ended. As will be described in detail later, when requesting details, the central control device 10 makes a connection permission of communication by the first communication circuit and a connection request of communication by the second communication circuit to the peripheral device 20. In response to this, the peripheral device 20 transmits the detailed information by using the second communication circuit. As described above, in the case of the second communication circuit, information of a large capacity can be transmitted.

In step S306, the control circuit 202 determines whether to transmit the topic information from the result of the state check process. When it is determined in step S306 that the topic information is determined to be transmitted, the process proceeds to step S307. When it is determined in step S306 that the topic information is determined not to be transmitted, the process of FIG. 11 is ended.

In step S307, the control circuit 202 transmits the advertising signal including the summary of the topic information determined to be transmitted by using the first communication circuit of the communication circuit 212. At this time, the control circuit 202 may include, in the advertising signal, information indicating that the information to be transmitted includes the summary of the topic information. After that, the process proceeds to step S308.

In step S308, the control circuit 202 determines whether there is a request for details from the central control device 10 has been received. When it is determined in step S308 that there is the request for details, the process proceeds to step S309. When it is determined in step S308 that there is no request for details, the process of FIG. 11 is ended.

In step S309, the control circuit 202 transmits detailed information including the details requested from the central control device 10 to the central control device 10 by, for example, using the communication circuit 212. After that, the process of FIG. 11 is ended.

As will be described in detail later, when requesting details, the central control device 10 makes a connection permission of communication by the first communication circuit and a connection request of communication by the second communication circuit to the peripheral device 20. In response to this, the peripheral device 20 transmits the detailed information by using the second communication circuit. As described above, in the case of the second communication circuit, information of a large capacity can be transmitted.

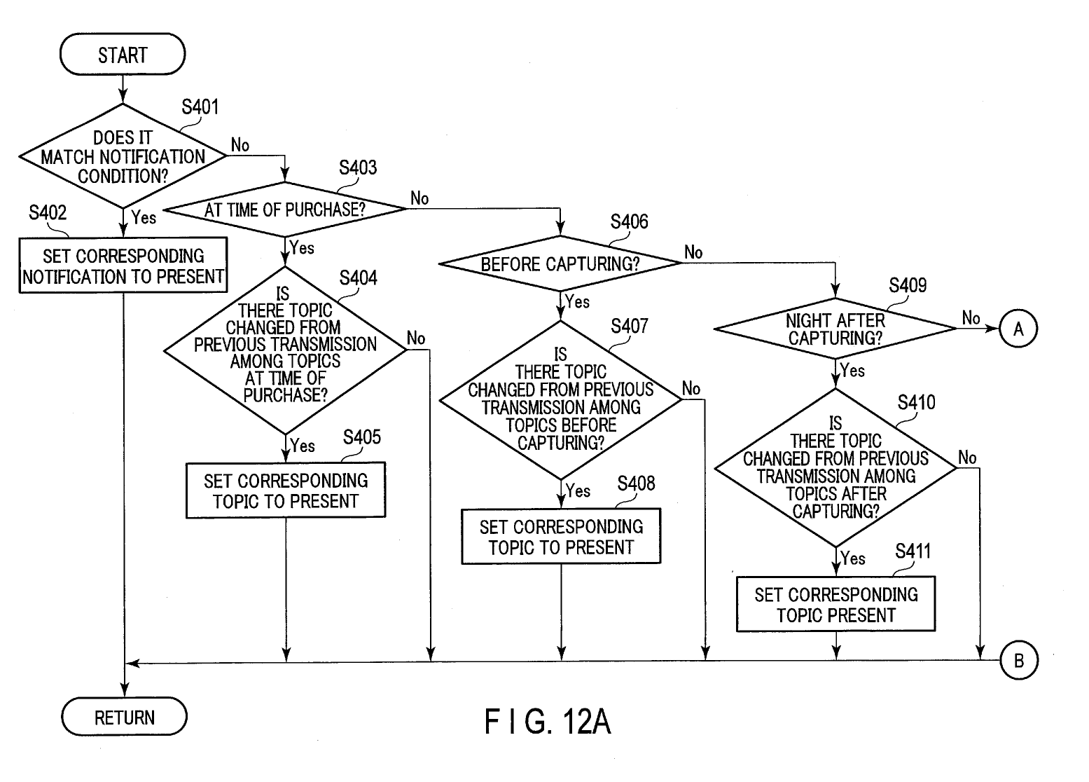

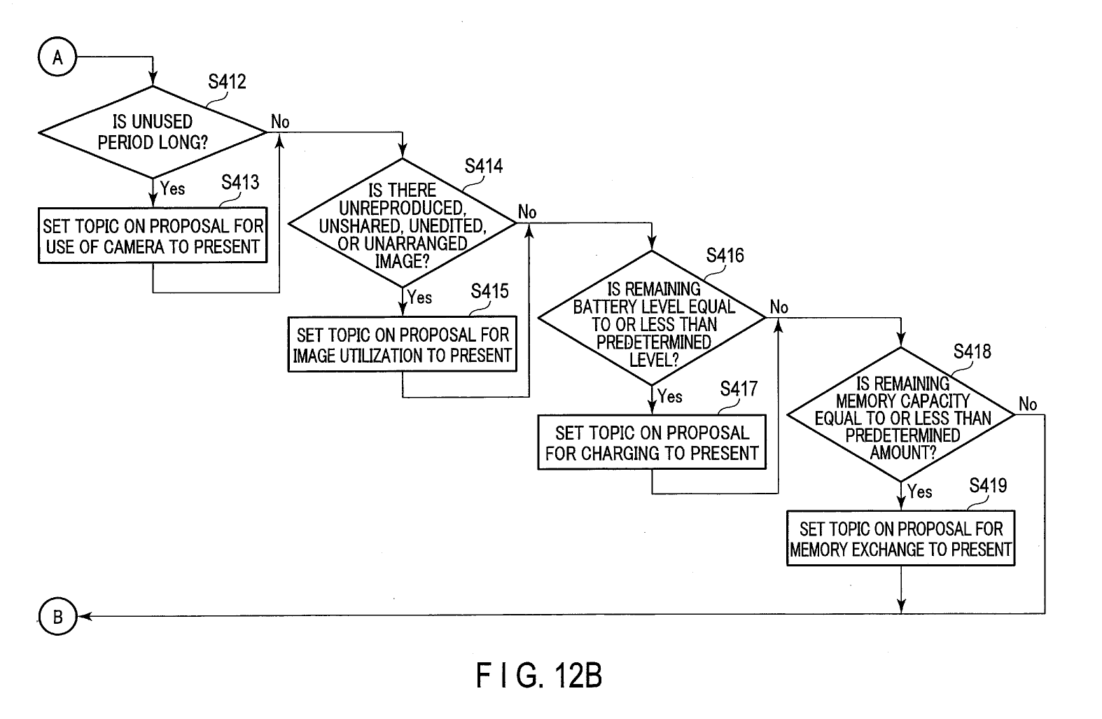

FIGS. 12A and 12B are flowcharts showing the state check process. Note that FIGS. 12A and 12B show the status check process for the digital camera. In step S401, the control circuit 202 determines whether the condition of any of the notifications illustrated in FIG. 8 is matched. In step S401, the control circuit 202 performs various determinations such as whether there is the remaining battery level, whether there is the memory capacity, whether the setting instructed by the user is completed, whether an error has occurred, and whether there are other notifications. Then, when any one of the conditions is satisfied, the control circuit 202 determines that the condition of the notification is matched. When it is determined in step S401 that the condition of the notification is matched, the process proceeds to step S402. When it is determined in step S401 that the condition of the notification is not matched, the process proceeds to step S403.

In step S402, the control circuit 202 sets the notification determined as matching the notification condition to “present”. Here, when the notification that needs to be contacted repeatedly is included in the notification determined to match the condition of the notification, the control circuit 202 associates repetitive information with the notification. That is, the control circuit 202 sets the state of the repetitive information of the notification to “present”. Furthermore, when information about a specific user is included in the notification determined to match the condition of the notification, the control circuit 202 associates security information with the notification. That is, the control circuit 202 associates the user name with the notification. After that, the processes of FIGS. 12A and 12B are ended. Therefore, the process branches from step S302 to step S303 in FIG. 11.

In step S403, the control circuit 202 determines whether the digital camera is currently purchased. At the time of purchase, for example, it is a fixed period such as three months after the user registration to the digital camera. When it is determined in step S403 that the digital camera is currently purchased, the process proceeds to step S404. When it is determined in step S403 that the digital camera is not currently purchased, the process proceeds to step S406.

In step S404, the control circuit 202 determines whether there is a change from the information previously transmitted to the central control device 10 among pieces of the information provided as a topic at the time of purchase. For example, when the number of sample images increases, it is determined that there is a change in the information about the proposal for the image utilization. In addition, for example, when there is a necessity of proposal for the use of the camera, such as the digital camera not being used after purchase, it is determined that there has been a change in the information about the proposal for the use of the camera. When it is determined in step S404 that there is the change, the process proceeds to step S405. When it is determined in step S404 that there is no change, the processes of FIGS. 12A and 12B are ended.

In step S405, the control circuit 202 sets the topic related to the information determined as being changed to “present”. Here, when the information that needs to be repeatedly contacted is included in the topic information determined as “present”, the control circuit 202 associates repetition information with the topic information. Furthermore, when a topic on a specific user is included in the topic information determined as “present”, the control circuit 202 associates security information with the topic information. After that, the processes of FIGS. 12A and 12B are ended. Therefore, the process branches from step S306 to step S307 in FIG. 11.

In step S406, the control circuit 202 determines whether it is currently before capturing. For example, when the schedule of the user's going out or the like is notified from the central control device 10 or the like, the morning on the outing day is also determined to be “before capturing”. In addition, when a live view display is in progress, it is determined that it is before capturing. When it is determined in step S406 that it is currently being capturing, the process proceeds to step S407. When it is determined in step S406 that it is not before capturing, the process proceeds to step S409.

In step S407, the control circuit 202 determines whether there is a change from the information previously transmitted to the central control device 10 among pieces of the information provided as a topic before capturing. For example, when a situation to propose the use of the accessory is predicted from the determination result of the capturing scene and the determination result of the subject, it is determined that there is a change in the information about the other topics. When it is determined in step S407 that there is the change, the process proceeds to step S408. When it is determined in step S407 that there is no change, the processes of FIGS. 12A and 12B are ended.

In step S408, the control circuit 202 sets the topic related to the information determined as being changed to “present”. Here, when it is necessary to repeatedly contact the topic information set to “present”, the control circuit 202 associates the topic information with the repetitive information. Furthermore, when information about the specific user is included in the topic information set to “present”, the control circuit 202 associates security information with the topic information. After that, the processes of FIGS. 12A and 12B are ended. Therefore, the process branches from step S306 to step S307 in FIG. 11.

In step S409, the control circuit 202 determines whether it is currently night after capturing. For example, when the current time is later than the time corresponding to the night and even one image is captured on the day, it is determined that it is the night after the capturing. The time corresponding to the night is, for example, 19:00. When it is determined in step S409 that it is currently the night after capturing, the process proceeds to step S410. When it is determined in step S409 that it is not currently the night after capturing, the process proceeds to step S412.

In step S410, the control circuit 202 determines whether there is a change from the information previously transmitted to the central control device 10 among pieces of the information provided as the topic on night after capturing. For example, it is useful to share images with family members when there is a group photograph of family in the images captured today. At this time, it is determined that there is a change in the information about the image utilization. When it is determined in step S410 that there is the change, the process proceeds to step S411. When it is determined in step S410 that there is no change, the processes of FIGS. 12A and 12B are ended.

In step S411, the control circuit 202 sets the topic related to the information determined as being changed to “present”. Here, when the information that needs to be repeatedly contacted is included in the topic information set to “present”, the control circuit 202 associates repetition information with the topic information. Furthermore, when information about the specific user is included in the topic information set to “present”, the control circuit 202 associates security information with the topic information. After that, the processes of FIGS. 12A and 12B are ended. Therefore, the process branches from step S306 to step S307 in FIG. 11.

In step S412, the control circuit 202 determines whether the unused period of the digital camera is longer than a predetermined period. For example, when the capturing is not performed for three months, it is determined that the unused period is longer than the predetermined period. When it is determined in step S412 that the unused period is longer than the predetermined period, the process proceeds to step S413. When it is determined in step S412 that the unused period is not longer than the predetermined period, the process proceeds to step S414.

In step S413, the control circuit 202 sets the topic information related to the proposal for the use of the camera to “present”. At this time, the control circuit 202 may associate the repetitive information with the topic information. After that, the process proceeds to step S414.

In step S414, the control circuit 202 determines whether there is an unreproduced, unshared, unedited, or unarranged image. For example, when there is an image that has never been reproduced, it is determined that there is the unreproduced image. In addition, for example, when there is an image that has never been shared, it is determined that there is the unshared image. When it is not a group photograph, it may be determined that it is not an image to be shared. In addition, for example, when there is an image which has never been edited, it is determined that there is the unedited image. Note that the image to be edited may be limited to movie images. In addition, when a failed image is included, it is determined that there is the unrearranged image. When it is determined in step S414 that there is the unreproduced, unshared, unedited, or unfinished image, the process proceeds to step S415. When it is determined in step S414 that there is not the unreproduced, unshared, unedited, or unfinished image, the process proceeds to step S416.

In step S415, the control circuit 202 sets the proposal for the image utilization to “present”. That is, the control circuit 202 sets “present” to those corresponding to the current situation among the proposal for image reproduction, the proposal for image share, the proposal for image editing, and the proposal for image organization. At this time, the control circuit 202 may associate repetitive information with the proposal. After that, the process proceeds to step S416.

In step S416, the control circuit 202 determines whether the remaining battery level is equal to or less than a predetermined level. Here, the predetermined level is, for example, larger than the remaining battery level used for determining the remaining battery level at the time of the notification. When it is determined in step S416 that the remaining battery level is equal to or smaller than the predetermined level, the process proceeds to step S417. When it is determined in step S416 that the remaining battery level is not equal to or smaller than the predetermined level, the process proceeds to step S418.

In step S417, the control circuit 202 sets the proposal for the charging to “present”. At this time, the control circuit 202 may associate repetitive information with the proposal. After that, the process proceeds to step S418.

In step S418, the control circuit 202 determines whether the remaining memory capacity is equal to or less than a predetermined amount. Here, the predetermined amount is, for example, larger than the remaining memory capacity used for determining the remaining memory capacity at the time of the notification. When it is determined in step S418 that the remaining memory capacity is equal to or smaller than the predetermined amount, the process proceeds to step S419. When it is determined in step S418 that the remaining memory capacity is mpt equal to or smaller than the predetermined amount, the processes of FIGS. 12A and 12B end.

In step S418, the control circuit 202 sets the proposal for the memory exchange to “present”. At this time, the control circuit 202 may associate repetitive information with the proposal. After that, the processes of FIGS. 12A and 12B are ended.

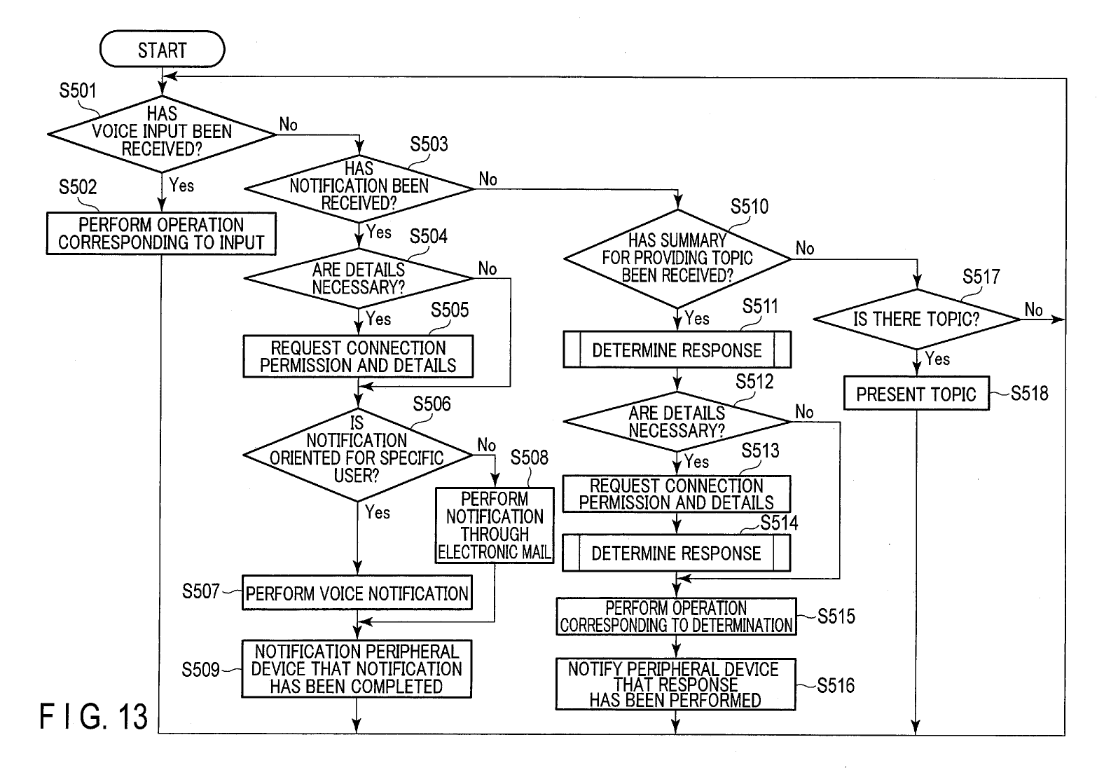

FIG. 13 is a flowchart showing the operation of the central control device 10 in the second embodiment. The operation of FIG. 13 is controlled by the AI assistant realized by the control circuit 102 or the like of the central control device 10.

In step S501, the AI assistant determines whether there is input of user's voice. When it is determined in step S501 that the user's voice is input, the process proceeds to step S502. When it is determined in step S501 that there is no input of the user's voice, the process proceeds to step S503. Note that when a specific activation word is set in the central control device 10, the processes after step S501 may not be performed until the user issues an activation word.

In step S502, the AI assistant recognizes the input voice and performs an operation corresponding to the recognized voice. After that, the process returns to step S501.

In step S503, the AI assistant determines whether the notification has been received from the peripheral device 20. When it is determined in step S503 that the notification has been received from the peripheral device 20, the process proceeds to step S504. When it is determined in step S503 that the notification has not been received from the peripheral device 20, the process proceeds to step S510.

In step S504, the AI assistant determines whether the details of the notification are necessary. For example, when it is sufficient to report only the presence or absence of notification to the user, it is determined that details of the notification are not necessary. On the other hand, in some circumstances, it is better to report the details of the error notification together. In such a case, it is determined that the details of the notification are necessary. When it is determined in step S504 that the details of the notification are necessary, the process proceeds to step S505. When it is determined in step S504 that the details of the notification are not necessary, the process proceeds to step S506.

In step S505, the AI assistant notifies the peripheral device 20 that the communication connection has been permitted by using the first communication circuit of the communication circuit 112. After that, the AI assistant performs a connection process with the peripheral device 20 by using the second communication circuit. After the communication connection is performed by the second communication circuit, the AI assistant requests details. After that, the process proceeds to step S506.

In step S506, the AI assistant determines whether the notification is for a specific user. When the security information is associated with the notification, it is determined that the notification is for the specific user. When it is determined in step S506 that the notification is not for the specific user, the process proceeds to step S507. When it is determined in step S506 that the notification is for the specific user, the process proceeds to step S508.

In step S507, the AI assistant performs a voice notification by using the speaker of the voice output circuit 108. In step S508, the AI assistant transmits an e-mail including the notification from the peripheral device 20 to the smartphone of the specific user by using the communication circuit 112. After step S507 or step S508, the process proceeds to step S509. Here, in step S507 or 5508, when details are not requested in step S505, the notification including no details is performed. In addition, in step S507 or S508, when details are requested in step S505, the notification including details is performed. In addition, when the repetition information is associated with the notification, the AI assistant performs notification at fixed time intervals until a report-unnecessary instruction is received from the user.

In step S509, the AI assistant notifies the peripheral device 20 that the notification has been performed by using, for example, the first communication circuit of the communication circuit 112. After that, the process returns to step S501. Note that the notification in step S509 may be performed after switching to the notification by the second communication circuit if the data amount increases.

In step S510, the AI assistant determines whether the topic information has been received from the peripheral device 20. When it is determined in step S510 that the topic information has been received from the peripheral device 20, the process proceeds to step S511. When it is determined in step S510 that the topic information has not been received from the peripheral device 20, the process proceeds to step S517.

In step S511, the AI assistant determines a response based on the provided topic information. After that, the process proceeds to step S512. Details of step S511 will be described later.

In step S512, the AI assistant determines whether the details of the provided topic information are necessary. When it is determined in step S511 that it is difficult to determine a response only by the summary of the topic, it is determined that details of the provided topic information is necessary. When it is determined in step S512 that the details of the provided topic information are necessary, the process proceeds to step S513. When it is determined in step S512 that the details of the provided topic information are not necessary, the process proceeds to step S515.

In step S513, the AI assistant notifies the peripheral device 20 that the communication connection has been permitted by using the first communication circuit of the communication circuit 112. After that, the AI assistant performs a connection process with the peripheral device 20 by using the second communication circuit. After the communication connection is performed by the second communication circuit, the AI assistant requests details. After that, the process proceeds to step S514.

In step S514, the AI assistant determines a response based on the provided topic information. After that, the process proceeds to step S515. Details of step S514 will be described later.

In step S515, the AI assistant performs an operation according to the determination of step S511 or step S514. After that, the process proceeds to step S516. Note that when the operation is performed, the AI assistant may convert information exchange with the peripheral device 20 into a voice or the like and report the same to the user.

In step S516, the AI assistant notifies the peripheral device 20 that the response has been performed based on the provided information by using, for example, the first communication circuit of the communication circuit 112. After that, the process returns to step S501. Note that the notification in step S516 may be performed after switching to the notification by the second communication circuit if the data amount increases.

In step S517, the AI assistant determines whether there is a topic to be newly reported to the user. When it is determined in step S517 that there is the topic to be newly reported to the user, the process proceeds to step S518. When it is determined in step S517 that there is no topic to be newly reported to the user, the process returns to step S501.

In step S518, the AI assistant reports the topic to the user by, for example, using the speaker of the voice output circuit 108. After that, the process returns to step S501.

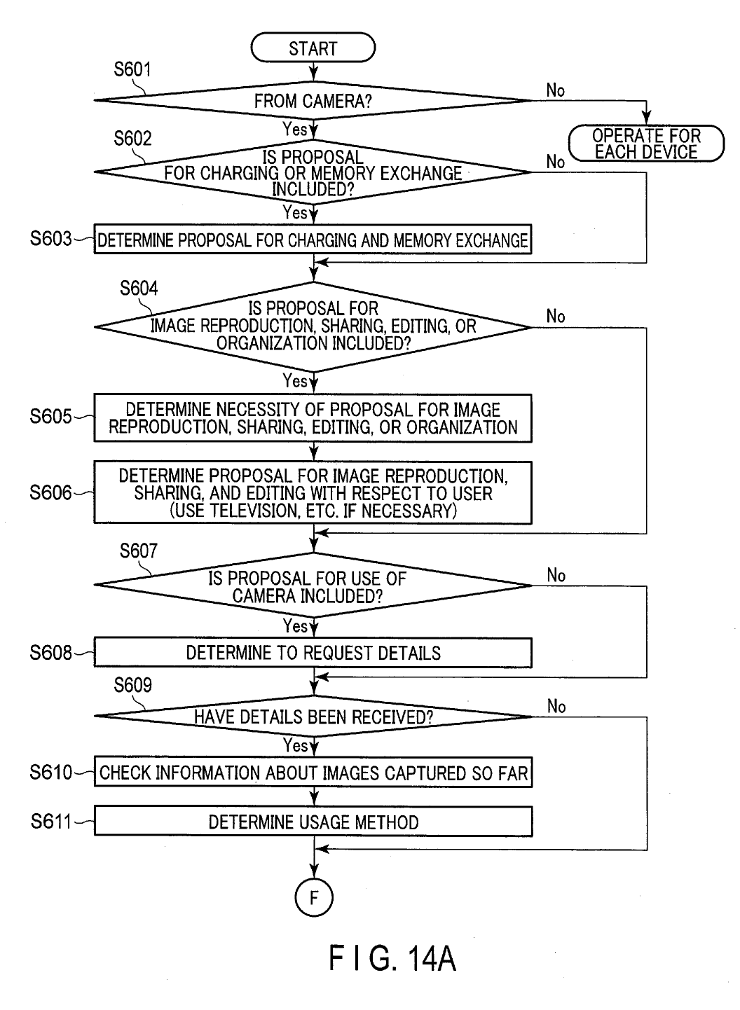

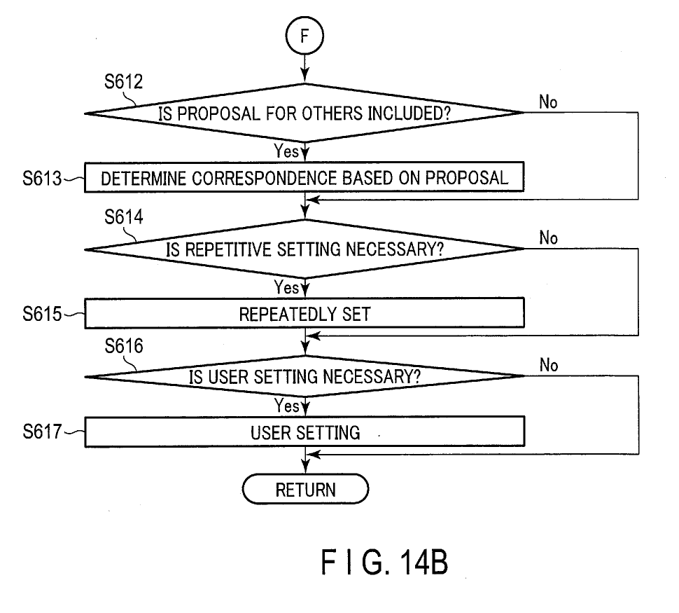

FIGS. 14A and 14B are flowcharts showing details of the response determination process in step S511 or step 5514 of FIG. 13. In step S601, the AI assistant determines whether the topic information is provided from the digital camera. When it is determined in step S601 that the topic information is provided from the digital camera, the process proceeds to step S602. When it is determined in step S601 that the topic information is not provided from the digital camera, a determination process according to each peripheral device is performed. Here, details of the determination process according to each peripheral device will not be described.

In step S602, the AI assistant determines whether topic information includes proposal for charging or memory exchange. For example, in the summary, when proposal for charging or memory exchange is set to be present, it is determined that the topic information includes proposal related to charging or memory exchange. In addition, for example, even when the information about the remaining battery level or the remaining memory capacity is provided as details, it is determined that the proposal includes proposal related to charging or memory exchange. When it is determined in step S602 that the topic information includes proposal related to charging or memory exchange, the process proceeds to step S603. When it is determined in step S602 that the topic information does not include proposal related to charging or memory exchange, the process proceeds to step S604.

In step S603, the AI assistant determines proposal for charging or memory exchange with respect to the user. After that, the process proceeds to step S604. In step S603, the AI assistant may determine to present the actual remaining battery level or the remaining memory capacity to the user at the proposal for charging or memory exchange. In this case, the AI assistant also determines to request the information about the remaining battery level or the remaining memory capacity as details.

In step S604, the AI assistant determines whether the topic information includes proposal for image reproduction, image sharing, image editing, and image organization. For example, in the summary, when proposal for image reproduction, image sharing, image editing, or image organization is set to “present”, it is determined that the topic information includes proposal related to image reproduction, image sharing, image editing, or image organization. In addition, for example, even when an image file name or an image file of a subject of proposal for image reproduction, image sharing, image editing, or image organization is provided as details, the topic information may be image reproduction, image sharing, image editing, or image organization. When it is determined in step S604 that the topic information includes proposal related to image reproduction, image sharing, image editing, or image organization, the process proceeds to step S605. When it is determined in step S604 that the topic information does not include proposal related to image reproduction, image sharing, image editing, or image organization, the process proceeds to step S607.

In step S606, the AI assistant determines proposal for image reproduction, image sharing, image editing, or image organization with respect to the user. After that, the process proceeds to step S607. When the display is provided in the central control device 10, images subjected to proposal for image reproduction, image sharing, image editing, or image organization may be displayed on the display. In addition, when no display is provided in the central control device 10, images subjected to proposal for image reproduction, image sharing, image editing, or image organization may be displayed on another peripheral device having a display, such as a television. In these cases, the AI assistant also determines to request the image file as details.

In step S607, the AI assistant determines whether topic information includes proposal related to the use of the camera. For example, in the summary, when proposal for the use of the camera is set to be present, it is determined that the topic information includes proposal related to the use of the camera. When it is determined in step S607 that the topic information includes proposal related to the use of the camera, the process proceeds to step S608. When it is determined in step S607 that the topic information does not include proposal related to the use of the camera, the process proceeds to step S609.

In step S608, the AI assistant determines to request the digital camera for the details of the previously captured image as details. In step S609, the AI assistant determines whether details have been received from the digital camera. When it is determined in step S609 that details have been received, the process proceeds to step S610. When it is determined in step S609 that details do not have been received, the process proceeds to step S612.

In step S610, the AI assistant checks the information about the images captured so far. Then, in step S611, the AI assistant determines how to use the digital camera for the user.

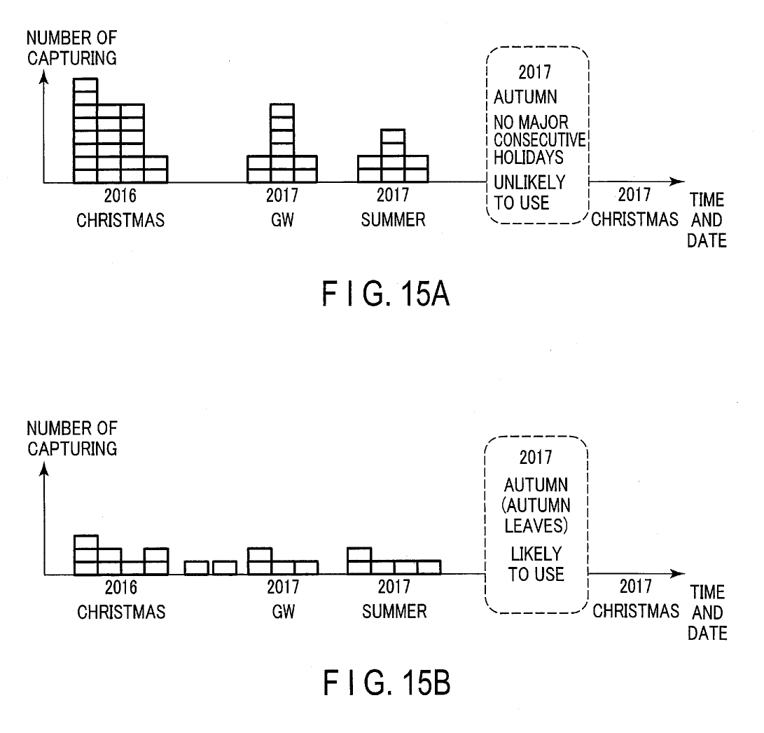

FIGS. 15A and 15B show examples of the capturing history of the user determined from the information about the images captured so far. Here, the horizontal axis in FIGS. 15A and 15B shows the passage of the capturing date and time, and the vertical axis in FIGS. 15A and 15B shows the number of capturing by the user.

In. FIG. 15A, it is understood that the user captures while concentrating on consecutive holidays such as winter vacation, golden week (GW), or summer vacation. In this case, when the present is autumn and there are no consecutive holidays, it can be determined that the demand for the camera for the user is not high. In such a case, the AI assistant determines not to propose the use of the camera to the user.

On the other hand, in FIG. 15B, it is understood that the user captures not only on the consecutive holidays but also on average. In this case, when the present is autumn, it can be determined that there is a demand for capturing of autumn leaves. In such a case, the AI assistant determines to propose the use of the camera to the user such as “the capturing season came” or “do not go capturing the autumn leaves?” At this time, if necessary, the AI assistant may complement the proposal for the use of the camera by searching the Internet, investigating the situation of autumn leaves in various places, and examining the weather.

In addition, when there are many failed images, the AI assistant may introduce tips to solve the failure as a proposal for the use of the camera.

Note that the determination as to the method of using the digital camera for the user illustrated in FIGS. 15A and 15B may be performed in the digital camera. In this case, the digital camera may provide information about the usage method determined in the digital camera as the detailed information.

In step S612, the AI assistant determines whether topic information includes proposal related to the others. For example, in the summary, when proposal for the others is set to be present, it is determined that the proposal includes proposal related to the others. When it is determined in step S612 that the topic information includes proposal related to the others, the process proceeds to step S613. When it is determined in step S612 that the topic information does not include proposal related to the others, the process proceeds to step S614.

In step S613, the AI assistant determines correspondence based on the contents of the proposal.

After that, the process proceeds to step S614. In step S613, the AI assistant may determine to request details as necessary.

In step S614, the AI assistant determines whether repetitive setting is necessary. For example, when there is a topic with which repetitive information is associated, it is determined that the repetitive setting is necessary. When it is determined in step S614 that the repetitive setting is necessary, the process proceeds to step S615. When it is determined in step S614 that the repetitive setting is not necessary, the process proceeds to step S616.

In step S615, the AI assistant repeatedly sets the corresponding topic. After that, the process proceeds to step S616. By repeating the setting, the corresponding topic is reported to the user at fixed time intervals. This report is ended, for example, when the user instructs the central control device 10 not to report.

In step S616, the AI assistant determines whether user setting is necessary. For example, when there is a topic with which security information is associated, it is determined that the user setting is necessary. When it is determined in step S616 that the user setting is necessary, the process proceeds to step S617. When it is determined in step S616 that the user setting is not necessary, the processes of FIGS. 14A and 14B are ended.

In step S617, the AI assistant performs the user setting with respect to the corresponding topic. After that, the processes of FIGS. 14A and 14B are ended. Due to the user setting, the response of the proposal or the like is performed with respect to a specific user.

As described above, according to the present embodiment, the information transmitted from the peripheral device is divided into the summary of the topic and the details of the topic. The summary is included in the advertising signal and transmitted. When the central control device can deal with only summary, the peripheral device does not transmit the detailed information. Therefore, in the second embodiment, the second information transmission and the third information transmission can be performed with low power consumption, as compared with the first embodiment. Such low power consumption is particularly useful for mobile peripheral devices such as digital cameras and smartphones with a limited remaining battery level.

In addition, in the second embodiment, the peripheral device transmits the advertising signal including provision of the topic only when there is a change from the previous transmission. Therefore, the AI assistant does not have to repeat similar determinations.

### Third Embodiment

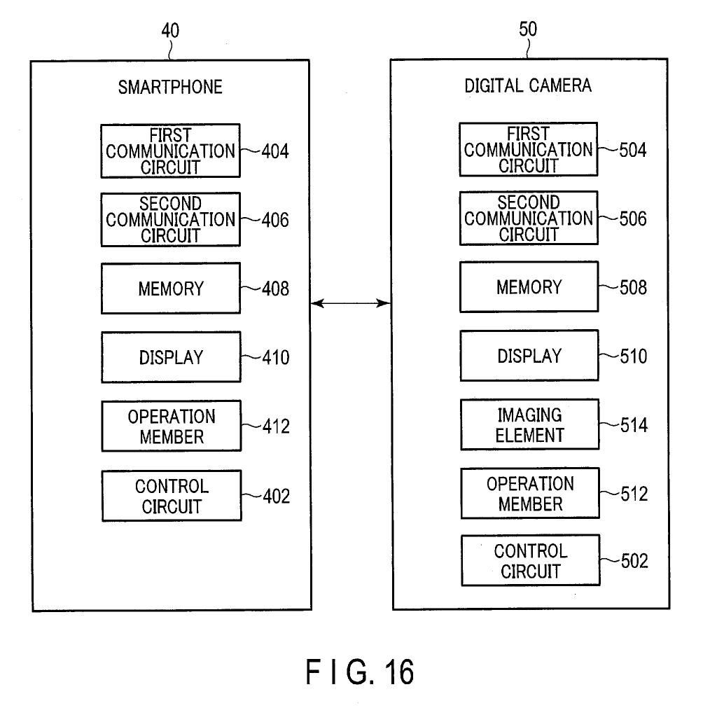

Next, a third embodiment will be described. The third embodiment is an application example of an advertising signal. FIG. 16 is a diagram illustrating a configuration of a communication system according to a third embodiment. In the third embodiment, a central control device is a smartphone 40. In addition, in the third embodiment, a peripheral device is a digital camera 50.

The smartphone 40 includes a control circuit 402, a first communication circuit 404, a second communication circuit 406, a memory 408, a display 410, and an operation member 412.

The control circuit 402 controls the operation of each block of the smartphone 40 according to a program stored in a memory 408. The control circuit 402 includes hardware such as a CPU, a GPU, an ASIC, an FPGA, and a main memory. Note that the control circuit 402 may be constituted by a single CPU or the like, or may be constituted by a plurality of CPUs or the like. In addition, some functions of the control circuit 402 may be realized by software.

The first communication circuit 404 is, for example, a communication circuit for low power consumption communication such as BLE. The second communication circuit 406 is, for example, a communication circuit for high capacity communication such as Wi-Fi. The smartphone 40 may include a communication circuit for cellular phone communication such as a 4G mobile phone line.

The memory 408 is a memory such as a flash memory. Various programs used by the smartphone 40 are stored in the memory 408. In addition, in the present embodiment, a camera application is stored in the memory 408. The camera application is an application for managing image files stored in the digital camera 50 and remotely controlling the digital camera 50. The memory 408 may be single or plural.

The display 410 displays various images. The display 510 is a display such as a liquid crystal display or an organic EL display.

The operation member 412 includes a touch panel. For example, the touch panel is provided integrally with the display screen of the display 410. The operation member 412 may include a mechanical operation member such as a button, a switch, and a dial.

The digital camera 50 includes a control circuit 502, a first communication circuit 504, a second communication circuit 506, a memory 508, a display 510, an operation member 512, and an imaging element 514.

The control circuit 502 controls the operation of each block of the digital camera 50 according to a program stored in a memory 508. The control circuit 502 includes hardware such as a CPU, a GPU, an ASIC, an FPGA, and a main memory. The control circuit 502 may be constituted by a single CPU or the like, or may be constituted by a plurality of CPUs or the like. In addition, some functions of the control circuit 502 may be realized by software.

The first communication circuit 504 is, for example, a communication circuit for low power consumption communication such as BLE. The second communication circuit 506 is, for example, a communication circuit for high capacity communication such as Wi-Fi.

The memory 508 is a memory such as a flash memory. Various programs used by the smartphone 40 are stored in the memory 508. Note that the memory 508 may be single or plural.

The display 510 displays various images. The display 510 is a display such as a liquid crystal display or an organic EL display.

The operation member 512 includes a mechanical operation member such as a button, a switch, and a dial. The operation member 512 may include a touch panel. For example, the touch panel is provided integrally with the display screen of the display 510.

The imaging element 514 is an imaging element such as a CCD sensor and a CMOS sensor. The imaging element 514 captures an image of a subject and generates an image signal.

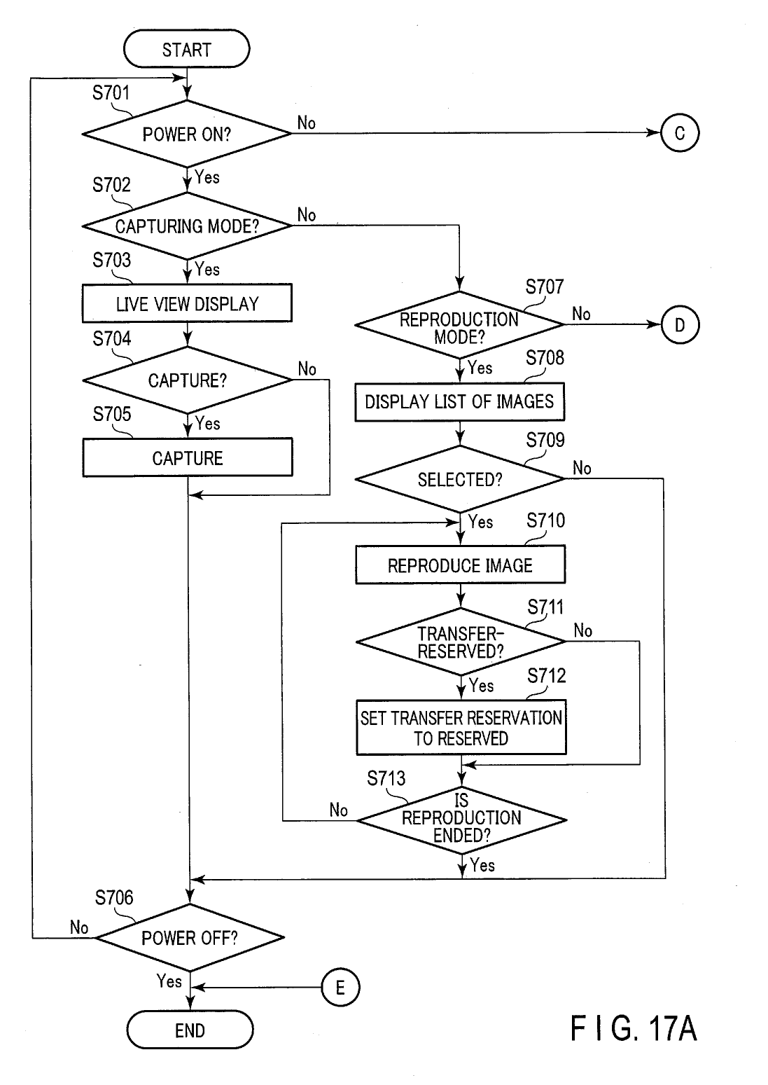

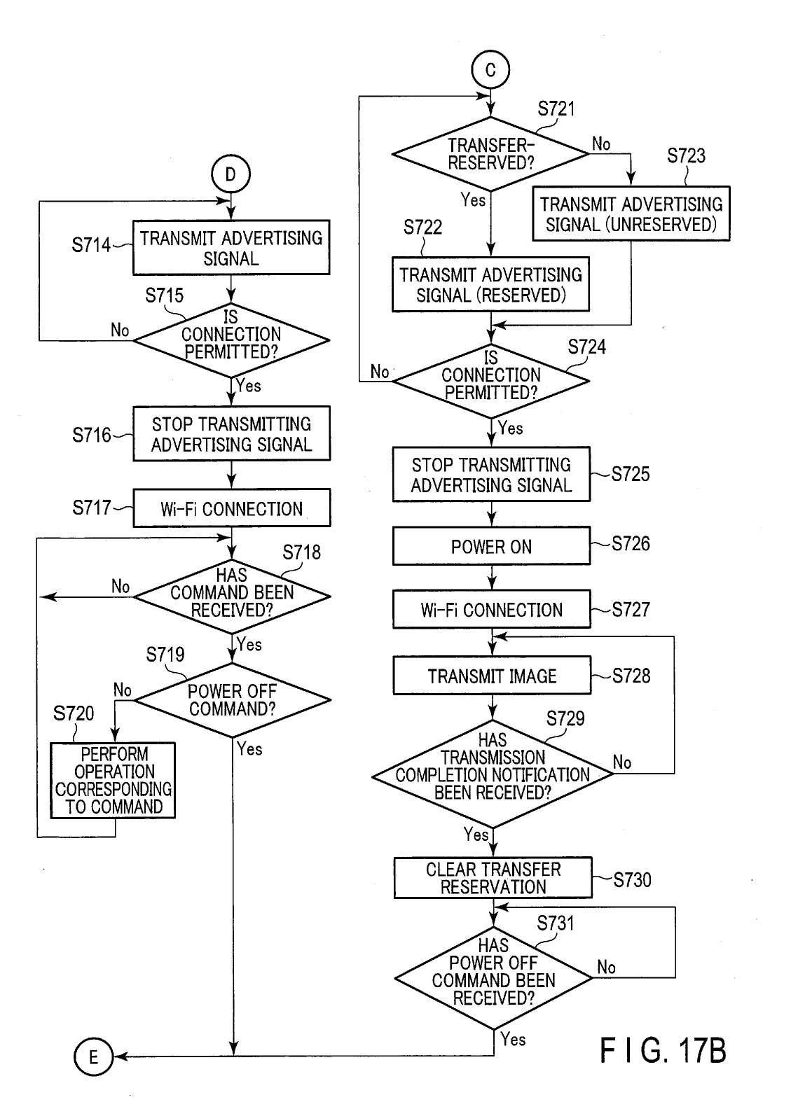

FIGS. 17A and 17B are flowcharts showing the operation of the digital camera 50 according to the third embodiment. In step S701, the control circuit 502 determines whether the digital camera 50 is powered on. When it is determined in step S701 that the digital camera 50 is powered on, the process proceeds to step S702. When it is determined in step S701 that the digital camera 50 is not powered on, the process proceeds to step S721.

In step S702, the control circuit 502 determines whether an operation mode of the digital camera 50 is a capturing mode. In the present embodiment, the digital camera 50 has a capturing mode, a reproduction mode, and a communication mode. The capturing mode is a mode for capturing an image. The reproduction mode is a mode for reproducing an image file. The communication mode is a mode in which a communication state is established with the smartphone 40. In the communication mode, the digital camera 50 waits for a command from the smartphone 40. When it is determined in step S702 that the operation mode is the capturing mode, the process proceeds to step S703. When it is determined in step S702 that the operation mode is not the capturing mode, the process proceeds to step S707.

In step S703, the control circuit 502 performs a live view display. After that, the process proceeds to step S704. In the live view display, the control circuit 502 repeats imaging by the imaging element 514. Then, the control circuit 502 causes the display 510 to display the live view image based on the image signals sequentially obtained from the imaging element 514.

In step S704, the control circuit 502 determines whether to capture an image. For example, when receiving a user's operation of a release button of the operation member 512, it is determined that the capturing is performed. When it is determined in step S704 that the capturing is performed, the process proceeds to step S705. When it is determined in step S704 that the capturing is not performed, the process proceeds to step S706.

In step S705, the control circuit 502 performs the capturing. After that, the process proceeds to step S706. In the capturing, the control circuit 502 performs imaging by the imaging element 514. Then, the control circuit 502 generates an image file from the image signal obtained by the imaging element 514. Then, the control circuit 502 stores the image file in the memory 508.

In step S706, the control circuit 502 determines whether to turn off the power of the digital camera 50. For example, when receiving an operation in which the user turns off the power switch of the operation member 512, it is determined that the power is turned off. When it is determined in step S706 that the power of the digital camera 50 is turned off, the processes of FIGS. 17A and 17B are ended. When it is determined in step S706 that the power of the digital camera 50 is not turned off, the process proceeds to step S701.

In step S707, the control circuit 502 determines whether the operation mode of the digital camera 50 is a reproduction mode. When it is determined in step S707 that the operation mode is the reproduction mode, the process proceeds to step S708. When it is determined in step S707 that the operation mode is not the reproduction mode, the process proceeds to step S714.

In step S708, the control circuit 502 causes the display 510 to display a list of image files stored in the memory 508.

In step S709, the control circuit 502 determines whether an image file has been selected by the user. For example, the image file is selected by the operation of the touch panel of the user. When it is determined in step S709 that the image file has been selected, the process proceeds to step S710. When it is determined in step S709 that the image file has not been selected, the process proceeds to step S706.

In step S710, the control circuit 502 reproduces the selected image file on the display 510.

In step S711, the control circuit 502 determines whether transfer reservation of the selected image file has been made. The transfer reservation is a reservation of transfer of the image file being reproduced to the smartphone 40. When the transfer reservation is set for the image file, the image file is automatically transmitted from the digital camera 50 to the smartphone 40. The transfer reservation is instructed by, for example, operating the touch panel of the user while reproducing the image file. When it is determined in step S711 that the transfer reservation has been made, the process proceeds to step S712. When it is determined in step S711 that the transfer reservation has not been made, the process proceeds to step S713.

In step S712, the control circuit 502 sets the transfer reservation setting of the image file being reproduced to “reserved”. This setting is stored in, for example, the control circuit 502. After that, the process proceeds to step S713.

In step S713, the control circuit 502 determines whether to end the reproduction of the image file. For example, when the end of the reproduction is instructed by the user's operation of the operation member 512, it is determined to end the reproduction of the image file. When it is determined in step S713 that the reproduction of the image file is ended, the process proceeds to step S706. When it is determined in step S713 that the reproduction of the image file is not ended, the process proceeds to step S710.

In step S714, the control circuit 502 transmits the advertising signal by using the first communication circuit 504 so as to establish the communication connection with the smartphone 40.

In step S715, the control circuit 502 determines whether the notification of connection permission of the BLE has been received from the smartphone 40. When it is determined in step S715 that the notification of connection permission of BLE is not received, the process returns to step S714. As described above, the advertising signal is transmitted until the communication connection of the BLE is established. Note that when the notification of connection permission of BLE cannot be received within a predetermined time, the process may proceed to step S706 after error notification to the user.

In step S716, the control circuit 502 stops transmitting the advertising signal. In step S717, the control circuit 502 performs a Wi-Fi connection process with the smartphone 40. For example, when receiving an ID and a password from the smartphone 40, the control circuit 502 establishes the Wi-Fi connection with the smartphone 40. After that, the digital camera 50 performs communication with the smartphone 40 by using the second communication circuit 506. Then, the digital camera 50 is in a state of receiving remote control from the smartphone 40.

In step S718, the control circuit 502 determines whether a command from the smartphone 40 has been received. In step S718, the process is on standby until it is determined that the command from the smartphone 40 has been received. When it is determined in step S718 that the command from the smartphone 40 has been received, the process proceeds to step S719.

In step S719, the control circuit 502 determines whether the received command is a power off command. When it is determined in step S719 that the command is the power off command, the processes of FIGS. 17A and 17B are ended. When it is determined in step S719 that the command is not the power off command, the process proceeds to step S720.

In step S720, the control circuit 502 performs an operation corresponding to the command. For example, when the received command is a capturing command, the control circuit 502 captures an image. For example, when the received command is a transfer command of an image file, the control circuit 502 sets the transfer reservation setting of the target image file to “reserved”. After the operation corresponding to the command, the process returns to step S718.

Step S721 is a process when the power of the digital camera 50 is turned off. In step S721, the control circuit 502 determines whether there is an image file reserved to be transferred. That is, the control circuit 502 determines whether there is an image file whose transfer reservation setting is “reserved”. When it is determined in step S721 that there is an image file reserved to be transferred, the process proceeds to step S722. When it is determined that there is no image file reserved to be transferred, the process proceeds to step S723.

In step S722, the control circuit 502 transmits an advertising signal including information of “transfer-reserved” by using the first communication circuit 504. In step S723, the control circuit 502 transmits an advertising signal including information of “transfer-unreserved” by using the first communication circuit 504. After step S722 or step S723, the process proceeds to step S724.

In step S724, the control circuit 502 determines whether the notification of connection permission of the BLE has been received from the smartphone 40. When it is determined in step S724 that the notification of connection permission of BLE is not received, the process returns to step S721. When the power is off, the advertising signal is periodically transmitted.

In step S725, the control circuit 502 stops transmitting the advertising signal.

In step S726, the control circuit 502 turns on the power of the digital camera 50 when receiving the power on command transmitted from the smartphone 40 together with the connection permission of the BLE.

In step S727, the control circuit 502 performs a Wi-Fi connection process with the smartphone 40.

In step S728, the control circuit 502 transmits the image file set to “transfer-reserved” to the smartphone 40 by using the second communication circuit 506. As described above, in the present embodiment, when there is an image file set to “transfer-reserved”, it is automatically transmitted to the smartphone 40. Here, the automatic transmission of the image file may be performed in a specific time zone such as nighttime. In addition, the automatic transmission of the image file may be performed when the communication situation is good.

In step S729, the control circuit 502 determines whether the transmission of the image file to the smartphone 40 has been completed. In step S729, when the transmission completion notification has been received from the smartphone 40, it is determined that the transmission of the image file has been completed. When it is determined in step S729 that the transmission of the image file to the smartphone 40 has not been completed, the process returns to step S728. When it is determined in step S729 that the transmission of the image file to the smartphone 40 has been completed, the process returns to step S730.

In step S730, the control circuit 502 clears the transfer reservation setting. Therefore, the repetitive transmission of the same image file is suppressed.

In step S731, the control circuit 502 determines whether the power off command has been received from the smartphone 40. In step S731, the process is on standby until it is determined that the power off command has been received. When it is determined in step S731 that the power off command has been received, the processes of FIGS. 17A and 17B are ended.

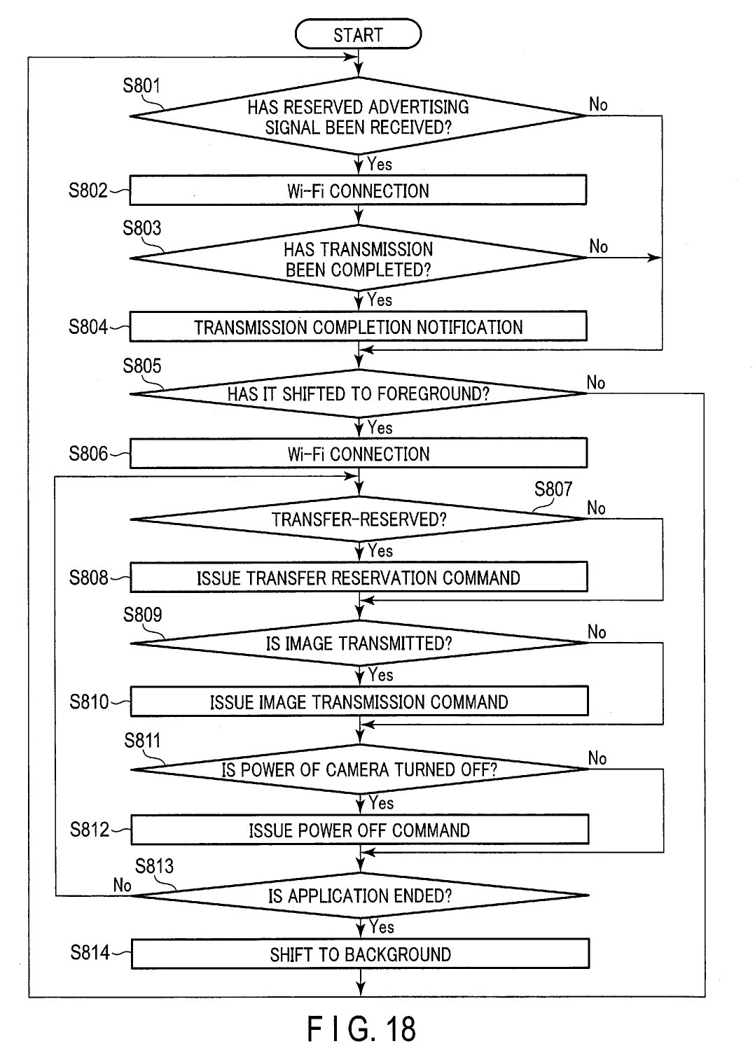

FIG. 18 is a flowchart showing the operation of the smartphone 40 in the third embodiment. In FIG. 18, a camera application is activated in a foreground or a background. When the camera application is activated in the foreground, the control circuit 402 operates according to the operation on the application by the user. When the camera application is activated in the background, the control circuit 402 performs a predetermined operation regardless of the user's operation.

In step S801, the control circuit 402 determines whether a “transfer-reserved” advertising signal has been received. The process of step S801 is performed even if the camera application is activated in the foreground or activated in the background. When it is determined in step S801 that the “transfer-reserved” advertising signal has been received, the process proceeds to step S802. When it is determined that the “transfer-reserved” advertising signal has not been received, the process proceeds to step S805.

In step S802, the control circuit 402 performs a process for Wi-Fi connection. To this end, the control circuit 402 transmits a notification of BLE connection permission to the digital camera 50 by using the first communication circuit 404. Therefore, the BLE communication between the smartphone 40 and the digital camera 50 is established. After that, in order to establish the Wi-Fi connection with the digital camera 50, the control circuit 402 transmits an ID and a password by using the first communication circuit 404. When the power of the digital camera 50 is turned off, the control circuit 402 transmits a power on command to the digital camera 50 by using the first communication circuit 404 prior to the transmission of the ID and the password.

In step S803, the control circuit 402 determines whether the transmission of the image file has been correctly completed. For example, when data loss or the like has occurred, it is determined that the transmission of the image file has not been correctly completed. When it is determined in step S803 that the transmission of the image file has been correctly completed, the process proceeds to step S804. When it is determined that the transmission of the image file has not been correctly completed, the process proceeds to step S805. At this time, error notification may be performed to the digital camera 50.

In step S804, the control circuit 402 transmits the transmission completion notification to the digital camera 50. After that, the process proceeds to step S805.

In step S805, the control circuit 402 determines whether the camera application is currently activated in the foreground. When it is determined in step S805 that the camera application is activated in the foreground, the process proceeds to step S806. When it is determined in step S805 that the camera application is activated in the background, the process proceeds to step S801. At this time, the control circuit 402 issues a power off command to the digital camera 50. The power off command is transmitted by using the first communication circuit 404.

In step S806, the control circuit 402 performs a process for Wi-Fi connection. The process for Wi-Fi connection is the same as that in step S802.

In step S807, the control circuit 402 determines whether a transfer reservation is performed. For example, when a transfer reservation for an image file stored in the digital camera 50 is instructed by a user's operation on the operation member 412 on the camera application, it is determined that the transfer reservation is performed. When it is determined in step S807 that the transfer reservation is performed, the process proceeds to step S808. When it is determined in step S807 that the transfer reservation is not performed, the process proceeds to step S809.

In step S808, the control circuit 402 issues a transfer reservation command to the digital camera 50. The transfer reservation command includes an image file name whose transfer reservation is instructed by the user. The transfer reservation command is transmitted by using the second communication circuit 406.

In step S809, the control circuit 402 determines whether image transmission is performed. For example, when an image transmission for an image file stored in the digital camera 50 is instructed by a user's operation on the operation member 412 on the camera application, it is determined that the image transmission is performed. When it is determined in step S809 that the image transmission is performed, the process proceeds to step S810. When it is determined in step S809 that the image transmission is not performed, the process proceeds to step S811.

In step S810, the control circuit 402 issues an image transmission command to the digital camera 50. The image transmission command includes an image file name whose transmission is instructed by the user. The image transmission command is transmitted by using the second communication circuit 406.

In step S811, the control circuit 402 determines whether to turn off the power of the digital camera 50. For example, when turning off the power of the digital camera 50 is instructed by the user's operation of the operation member 412 on the camera application, it is determined that the power of the digital camera 50 is turned off. When it is determined in step S811 that the power of the digital camera 50 is turned off, the process proceeds to step S812. When it is determined in step S811 that the power of the digital camera 50 is not turned off, the process proceeds to step S813.

In step S812, the control circuit 402 issues a power off command to the digital camera 50. This power off command is transmitted by using the second communication circuit 406.

In step S813, the control circuit 402 determines whether to end the foreground operation of the camera application. When the end of the operation in the foreground is instructed by the user's operation, it is determined that the foreground operation of the camera application is ended. When it is determined in step S813 that the operation of the camera application in the foreground is not ended, the process returns to step S807. When it is determined in step S813 that the operation of the camera application in the foreground is ended, the process returns to step S814.

In step S814, the control circuit 402 shifts the camera application to the background. After that, the process returns to step S801.

As described above, in the present embodiment, the advertising signal includes information about the presence or absence of transfer reservation as the summary of topic information. Therefore, the information about the presence or absence of transfer reservation with low power consumption is transmitted to the smartphone 40. In this way, a variety of information can be transmitted with low power consumption by including information other than a QUID in the advertising signal.

In the embodiment, the portion described as “part” (section or unit) may be constituted by combining a dedicated circuit or a plurality of general-purpose circuits, and if necessary, may be constituted by combining a microcomputer that operates according to preprogrammed software, a processor such as a CPU, or a sequencer such as an FPGA. It is also possible to perform design such that an external device takes over all or part of the control, and in this case, a wired or wireless communication circuit is interposed therebetween. The communication may be performed through Bluetooth communication, Wi-Fi communication, a telephone line, or the like, and may be performed through a USB or the like. A dedicated circuit, a general-purpose circuit, or a control unit may be integrated as an ASIC.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A peripheral device communicating with a central control device, the peripheral device comprising:
a control circuit configured to transmit first information including a topic to be provided to the central control device or a user of the central control device,
wherein the first information includes information for proposal to the central control device or the user of the central control device in relation to at least one of information about a current situation of the peripheral device and information about a function of the peripheral device.

2. The peripheral device according to claim 1, wherein the first information includes a summary of at least one of information about a current situation of the peripheral device and information about a function of the peripheral device, and
the control circuit further receives a request from the central control device which has received the first information, and transmits, to the central control device, second information indicating details of at least one of the information about the current state of the peripheral device and the information about the function of the peripheral device.

3. The peripheral device according to claim 1, wherein the control circuit transmits an advertising signal which is a signal for allowing the central control device to discover the peripheral device, and
the first information is included in the advertising signal.

4. A communication system comprising at least a peripheral device and a central control device that communicates with the peripheral device,
wherein the peripheral device comprises a first control circuit configured to transmit first information including a topic to be provided to the central control device or a user of the central control device,
the central control device comprises a second control circuit configured to determine a response based on the received first information and perform the determined response,
wherein the first information includes information for proposal to the central control device or the user of the central control device in relation to at least one of information about a current situation of the peripheral device and information about a function of the peripheral device.

5. The communication system according to claim 4, wherein the first control circuit further receives a request from the central control device which has received the first information, and transmits second information indicating details of information for proposal to the central control device or the user of the central control device in association with at least one of the information about the current state of the peripheral device and the information about the function of the peripheral device, and
the second control circuit further determines a response based on the received second information and performs the determined response.

6. The communication system according to claim 4, wherein the first control circuit transmits an advertising signal which is a signal for allowing the central control device to discover the peripheral device, and
the first information is included in the advertising signal.

7. The communication system according to claim 5, wherein the second control circuit integrates the first information transmitted from each of a plurality of peripheral devices and determines the response.

8. The communication system according to claim 5, wherein the second control circuit integrates the first information and the second information transmitted from each of a plurality of peripheral devices and determines the response.

9. The communication system according to claim 4, wherein the central control device comprises an interactive interface using a voice.

10. The communication system according to claim 4, wherein the second control circuit determines the correspondence by artificial intelligence.

11. A communication method of a communication system including a peripheral device and a central control device that communicates with the peripheral device, the communication method comprising:
transmitting, by the peripheral device, first information including a topic to be provided to the central control device or a user of the central control device;
determining, by the central control device, a response based on the received first information; and
performing the determined response,
wherein the first information includes information for proposal to the central control device or the user of the central control device in relation to at least one of information about a current situation of the peripheral device and information about a function of the peripheral device.

12. A non-transitory computer-readable recording medium having recorded thereon a communication program in a communication system including a peripheral device and a central control device that communicates with the peripheral device, the communication program comprising:
receiving, from the peripheral device, first information including a topic to be provided to the central control device or a user of the central control device; and
determining a response based on the received first information,
wherein the first information includes information for proposal to the central control device or the user of the central control device in relation to at least one of information about a current situation of the peripheral device and information about a function of the peripheral device.
